(19) United States
(12) Patent Application Publication
(10) Pub. No.: US 2017/0092075 A1
(43) Pub. Date: Mar. 30, 2017

(54) DEALER SUBSTITUTE DEVICE

(71) Applicants: Universal Entertainment Corporation, Tokyo (JP); Aruze Gaming (Hong Kong) Limited, Kowloon (HK)

(72) Inventors: Yoshinao USUKI, Tokyo (JP); Satoshi JOKO, Tokyo (JP); Yoshihiro NAGASAKI, Tokyo (JP)

(21) Appl. No.: 15/269,898

(22) Filed: Sep. 19, 2016

(30) Foreign Application Priority Data
Sep. 25, 2015 (JP) 2015-188956
Sep. 25, 2015 (JP) 2015-188957
Sep. 25, 2015 (JP) 2015-188958
Sep. 25, 2015 (JP) 2015-188959
Sep. 25, 2015 (JP) 2015-188960

(51) Int. Cl. G07F 17/32; A63F 1/14; A63F 9/04; A63F 5/00

(52) U.S. Cl. CPC G07F 17/3288; A63F 5/00; A63F 1/14; A63F 9/04; A63F 9/0406; G07F 17/3293; G07F 17/3206; A63F 2009/0408

(57) ABSTRACT

A dealer substitute device 1 includes: a right arm 12 and a left arm 13 configured to move a first handling portion 14, with which a gaming tool 2 used in a game is handled, so as to position the first handling portion 14 at a predetermined position in a three-dimensional space; and a trunk 11 which supports the right arm 12 and the left arm 13 and is configured to perform effect operation to a player.

### CROSS REFERENCE TO RELATED APPLICATION

The present application claims priority from Japanese Patent Applications Nos. 2015-188960, 2015-188959, 2015-188958, 2015-188957, 2015-188956 which were filed on Sep. 25, 2015, the disclosure of which is herein incorporated by reference in its entirety.

### FIELD OF THE INVENTION

The present invention relates to a dealer substitute device.

### BACKGROUND OF THE INVENTION

There has been developed automation of the operation of gaming machines having been conducted by a human dealer. For example, Specification of Japanese Patent No. 4676236 discloses a roulette apparatus as a kind of such a gaming machine. To be more specific, the above document discloses the roulette apparatus including ball pockets into one of which a ball spun on a roulette wheel with marks arranged thereon falls, the roulette apparatus being configured to eject air compressed by a compressor is into the one of the ball pockets holding the ball toward a bank track so as to spin the ball toward the bank track by pneumatic pressure.

In such a roulette apparatus, all the operations such as the operation of spinning the ball are performed by the roulette apparatus, and therefore, the gaming environment without the presence of a dealer, which has a totally non-traditional atmosphere, is provided to a player. However, some players prefer the atmosphere in which a dealer is present.

In view of the above, an objective of the present invention to provide a dealer substitute device which provides a player with a gaming environment resembling the atmosphere in which a dealer is present.

### BRIEF SUMMARY OF THE INVENTION

According to an embodiment the present invention, a dealer substitute device includes: an arm configured to move a handling portion, with which a gaming tool used in a game is handled, so as to position the handling portion at a predetermined position in a three-dimensional space; and a trunk which supports the arm and is configured to perform effect operation to a player.

In the above arrangement, the gaming tool is handled with the arm which is capable of moving the handling portion to a predetermined position in the three-dimensional space, and the trunk supporting the arm performs effect operation to the player, and thereby behavior close to an arm and trunk of a dealer handling the gaming tool is produced. As a result, a gaming environment resembling the atmosphere in which a dealer handles the gaming tool is provided to the player.

The device of the present invention may further include: a communication mechanism including a camera mechanism configured to acquire an image, a microphone mechanism configured to acquire sound, and a speaker mechanism configured to output sound, the communication mechanism being configured to communicate with the player; and a controller configured to execute the process of obtaining player information based on the image of the player acquired by the camera mechanism and based on the sound of the player acquired by the microphone mechanism, and outputting response information corresponding to the player information through the speaker mechanism.

In this arrangement, communication with the player is conducted through the acquisition of the image and sound and through the output. With this, a gaming environment further resembling the atmosphere in which a human dealer handles the gaming tool is provided to the player.

The device of the present invention may be arranged such that: the arm includes a plurality of arms which are arranged symmetrically with respect to the trunk; and a head provided with the communication mechanism is provided on top of the trunk.

In this arrangement, the arms are arranged symmetrically with respect to the trunk, and the head provided with the communication mechanism is provided on top of the trunk. With this, the dealer substitute device has a humanoid shape, and therefore a gaming environment further resembling the atmosphere in which a human dealer handles the gaming tool is provided to the player.

As described above, with the present invention, a gaming environment resembling an atmosphere in which a dealer is present is provided to a player.

### BRIEF DESCRIPTION OF THE DRAWINGS

Other and further objects, features and advantages of the invention will appear more fully from the following description taken in connection with the accompanying drawings in which:

FIG. 1 is an explanatory diagram illustrating a state where a dealer substitute device is combined with a roulette apparatus.

FIG. 2 is an explanatory diagram for a robotic device.

FIG. 3 is a block diagram of a dealer substitute device.

FIG. 4 is an explanatory diagram illustrating the state where the dealer substitute device is combined with the roulette apparatus.

FIG. 5 is an explanatory diagram illustrating the state where the dealer substitute device is combined with the roulette apparatus.

FIG. 6 is an explanatory diagram illustrating the state where the dealer substitute device is combined with the roulette apparatus.

FIG. 7 is an explanatory diagram illustrating the state where the dealer substitute device is combined with the roulette apparatus.

FIG. 8A is an explanatory diagram illustrating the state where the dealer substitute device is combined with the roulette apparatus.

FIG. 8B is an explanatory diagram illustrating the state where the dealer substitute device is combined with the roulette apparatus.

FIG. 8C is an explanatory diagram illustrating the state where the dealer substitute device is combined with the roulette apparatus.

FIG. 9A is an explanatory diagram showing an operation state of a shooting mechanism.

FIG. 9B is an explanatory diagram showing an operation state of the shooting mechanism.

FIG. 10 is an explanatory diagram showing an operation state of a holding mechanism.

FIG. 11 is a block diagram of a gaming system.

FIG. 12 is a block diagram of the gaming system.

FIG. 13 is a block diagram of the gaming system.

FIG. 14 is a block diagram of the gaming system.

FIG. 15 is a block diagram of the dealer substitute device.

FIG. 16 is a block diagram of the robotic device.

FIG. 17 is an explanatory diagram of an operation flag table.

FIG. 18A is a flowchart of a host main process.

FIG. 18B is a flowchart of a roulette main process.

FIG. 18C is a flowchart of a robot main process.

FIG. 19A is a flowchart of a bet receiving process.

FIG. 19B is a flowchart of a roulette bet receiving process.

FIG. 19C is a flowchart of a robot bet receiving effect process.

FIG. 20A is a flowchart of a game start effect process.

FIG. 20B is a flowchart of a roulette game start effect process.

FIG. 20C is a flowchart of a robot game start effect process.

FIG. 21A is a flowchart of a game running process.

FIG. 21B is a flowchart of a roulette game running process.

FIG. 21C is a flowchart of a robot game running process.

FIG. 22A is a flowchart showing a settlement process.

FIG. 22B is a flowchart of a roulette game settlement effect process.

FIG. 22C is a flowchart of a robot game settlement effect process.

### DETAILED DESCRIPTION OF THE PREFERRED EMBODIMENTS

The following will describe an embodiment of the present invention with reference to the drawings.

(Dealer Substitute Device 1: Schematic Structure)

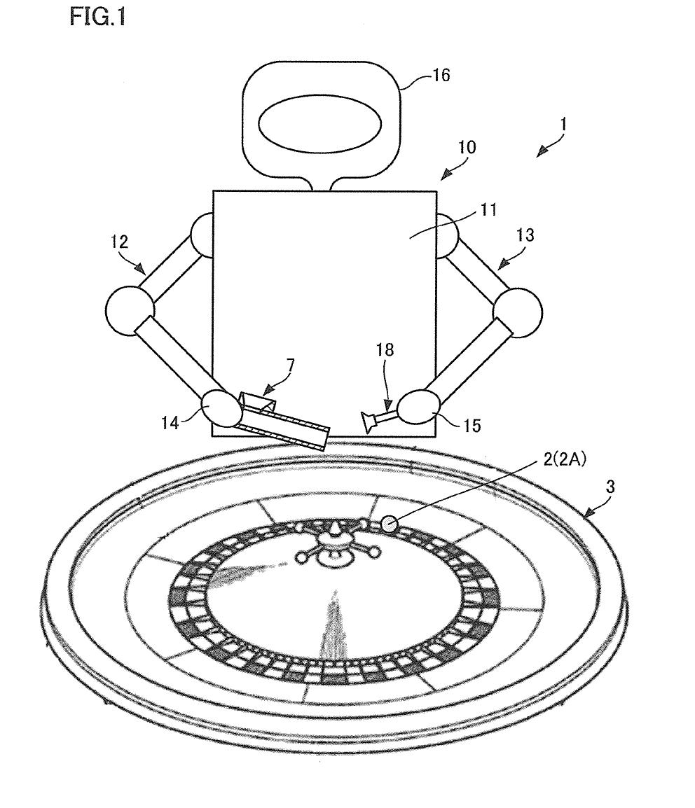

As shown in FIG. 1, a dealer substitute device 1 of the present embodiment includes a robotic device 10 configured to handle a gaming tool 2 used in a game such as a roulette game. The dealer substitute device 1 is configured to substitute for a part of or the entirety of a dealer who conducts a game, through operation of the robotic device 10. The following description deals with a gaming system for a roulette game in which the dealer substitute device 1 is combined with a roulette apparatus 3; however, the present invention is not limited to this.

The robotic device 10 of the dealer substitute device 1 includes: a right arm 12 (first arm); a left arm 13 (second arm); and a trunk 11 supporting the arms 12 and 13. Each of the first and second arms 12 and 13 has a plurality of degrees of freedom so as to correspond to an elbow and a wrist of a human body, and is coupled to the trunk 11 with degrees of freedom in a front-back direction and a left-right direction so as to correspond to a shoulder.

The right arm 12 includes a first handling portion 14 with which the gaming tool 2 used in the game is handled. The present embodiment will be described using a roulette ball 2A of a roulette game as the gaming tool 2. However, the gaming tool 2 is not limited to the roulette ball 2A. Cards function as the gaming tool 2 in a card game, and dice function as the gaming tool 2 in a dice game.

The first handling portion 14 is provided with a shooting mechanism 17 configured to discharge the gaming tool 2 by compressed air. The left arm 13 includes a second handling portion 15 with which the gaming tool 2 used in the game is handled. The second handling portion 15 is provided with a holding mechanism 18 configured to hold the gaming tool 2 by decompression and to transfer the gaming tool 2 to the shooting mechanism 17. With this, the mechanism and operation of the dealer substitute device 1 are simplified as compared with the case where the gaming tool 2 is held and shot with a handling portion of a single arm. The details of the shooting mechanism 17 and the holding mechanism 18 will be described later.

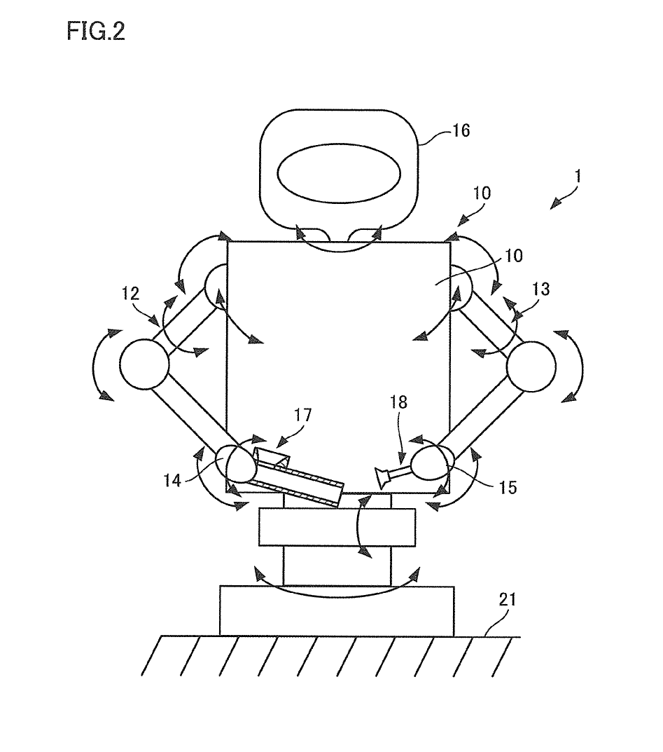

As shown in FIG. 2, the arms 12 and 13 are configured to move their respective handling portions 14 and 15 so as to position the handling portions 14 and 15 at respective predetermined positions in a three-dimensional space. On top of the trunk 11, there is provided a head 16 which is rotatable to the left and right. Further, a lower portion of the trunk 11 has a plurality of degrees of freedom so as to be rotatable and to be swingable in the front-back direction. The trunk 11 is capable of performing effect operation to the player by changing its posture by virtue of the plurality of degrees of freedom. In addition, the trunk 11 is designed to be fixable to a table 21 to enable installation in various places such as the roulette apparatus 3.

In the present embodiment, the robotic device 10 has the two arms which are the right arm 12 and the left arm 13 in order to have a body shape closest to a human dealer. However, the robotic device 10 does not have to have these two arms as long as the robotic device 10 has at least one arm.

In the above arrangement, the gaming tool 2 is handled with the arms 12 and 13 which are respectively capable of moving the handling portions 14 and 15 to respective predetermined positions in the three-dimensional space, and the trunk 11 supporting the arms 12 and 13 performs effect operation to the player, and thereby the behavior close to the arms and trunk of a dealer handling the gaming tool 2 is produced. As a result, the gaming environment resembling an atmosphere in which a dealer handles the gaming tool 2 is provided to the player.

Further, in the above arrangement, the gaming tool 2 is handled with the first and second arms 12 and 13 which are respectively capable of moving the first and second handling portions 14 and 15 to respective predetermined positions in the three-dimensional space. With this, as compared with the case where the gaming tool is handled with a single arm, the behavior of the arms and trunk of a dealer can be simulated by combining simple movement elements.

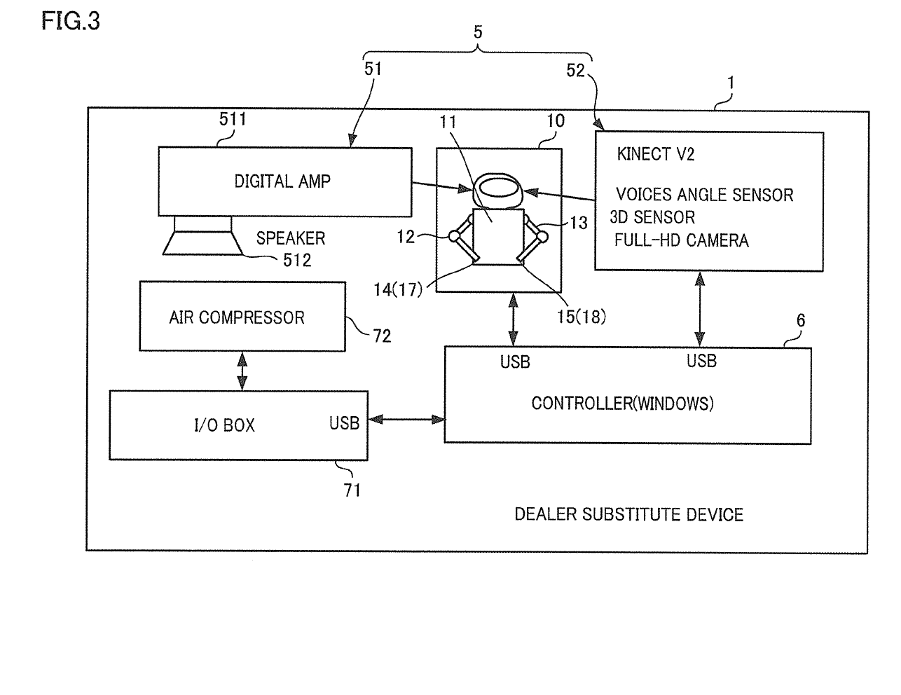

As shown in FIG. 3, the right arm 12 and the left arm 13 are arranged symmetrically with respect to the trunk 11. The head 16 provided on top of the trunk 11 is provided with a communication mechanism 5 configured to communicate with the player. Thus, the arms 12 and 13 are arranged symmetrically with respect to the trunk 11, and the head 16 provided with the communication mechanism 5 is provided on top of the trunk 11. With this, the robotic device 10 has a shape of a human upper body, and therefore a gaming environment further resembling the atmosphere in which a human dealer handles the gaming tool 2 is provided to the player.

The communication mechanism 5 includes: an information output mechanism 51 configured to output response information to the player; and an information acquisition mechanism 52 configured to acquire various types of external information such as sound, posture, motion, expression, and the like, from the player. Examples of the information output mechanism 51 include a speaker mechanism configured to output sound. The speaker mechanism includes: a digital amplifier 511 which amplifies audio signals; a speaker 512 which converts electrical signals from the digital amplifier 511 to sound waves and outputs sound. Examples of the information acquisition mechanism 52 include a camera mechanism configured to acquire an image and a microphone mechanism configured to acquire sound. The camera mechanism includes at least one of a voice angle sensor, a 3D sensor, and a full-HD camera.

(Controller 6)

The dealer substitute device 1 further includes a controller 6 configured to control the communication mechanism 5. The controller 6 is configured to execute the process of obtaining player information as external information based on the image of the player acquired by the camera mechanism and based on the sound of the player acquired by the microphone mechanism, and then outputting response information corresponding to the player information from the information output mechanism 51 (speaker mechanism). Thus, in the dealer substitute device 1, communication with the player is conducted through the acquisition of the image and sound and through the output. With this, a gaming environment further resembling the atmosphere in which a human dealer handles the gaming tool 2 is provided to the player.

Further, the controller 6 is configured to control the operation of the arms 12 and 13 and the trunk 11. To be more specific, the controller 6 controls the arms 12 and 13 so as to move the respective handling portions 14 and 15 to respective predetermined positions in the three-dimensional space, and the controller 6 controls the operation of the trunk 11 so as to perform the effect operation to the player.

The controller 6 is connected to an I/O box 71 having an input unit and an output unit. The I/O box 71 is connected to an air compressor 72 provided with an air control valve and the like. The air compressor 72 is connected to the shooting mechanism 17 of the first handling portion 14 and to the holding mechanism 18 of the second handling portion 15 via air tubes which are not illustrated. The air compressor 72 is capable of discharging compressed air and sucking air. The controller 6 is configured to control the air control valve of the air compressor 72 through the I/O box 71 so as to have the shooting mechanism 17 and the holding mechanism 18 operate at respective predetermined timings, thereby to perform operation of handling the gaming tool 2 in the game, in association with the motion of the trunk 11 and the arms 12 and 13.

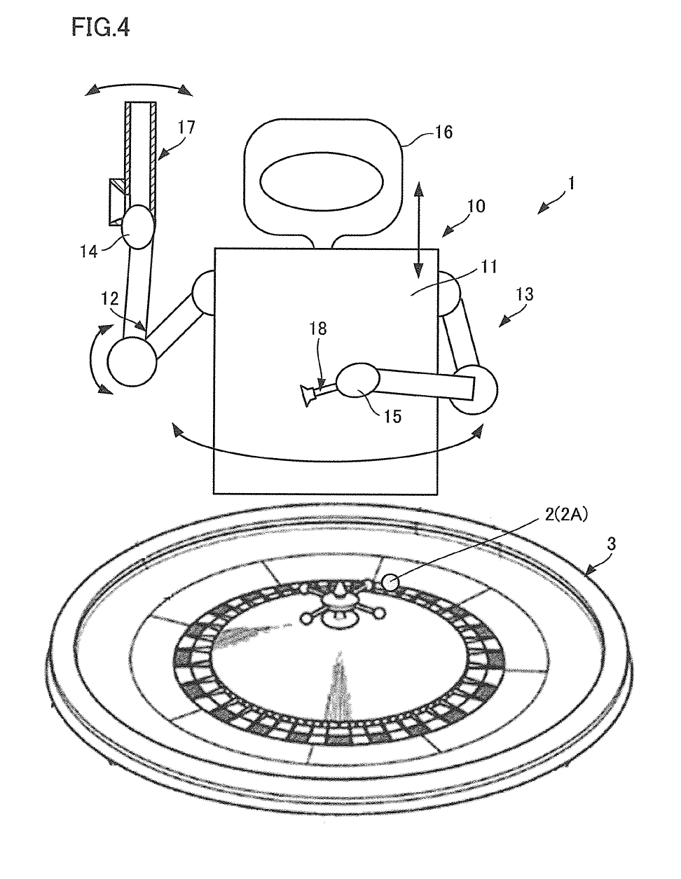

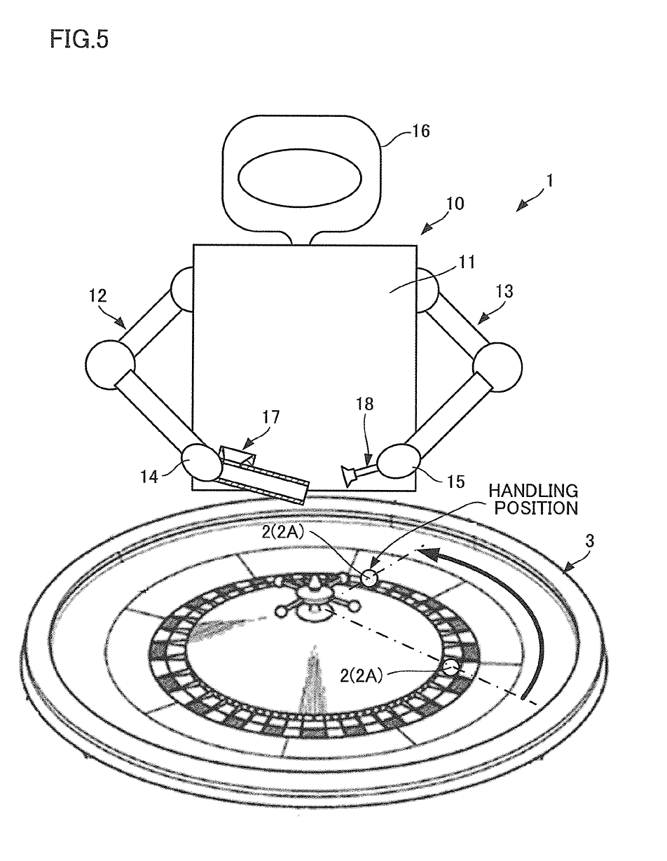

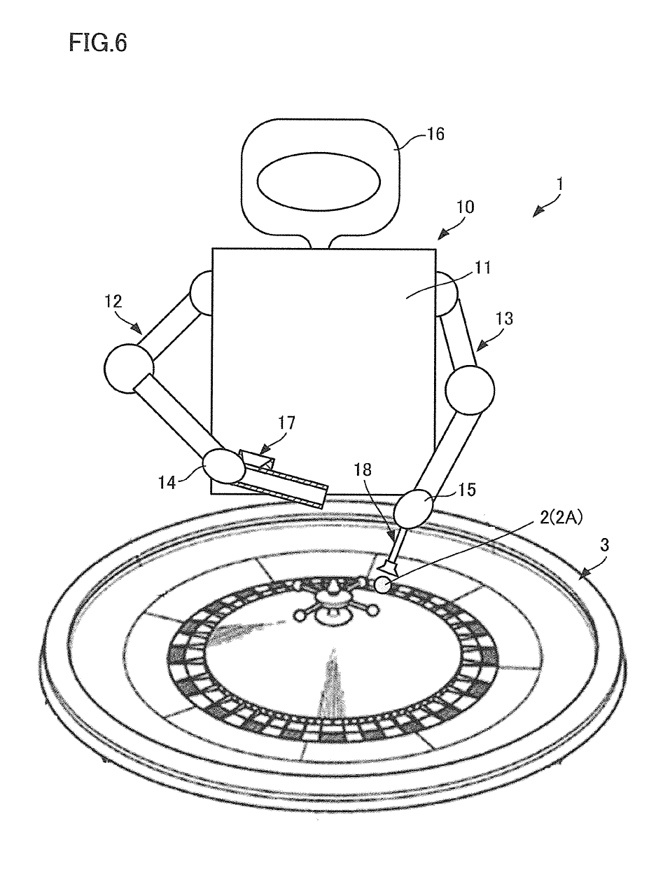

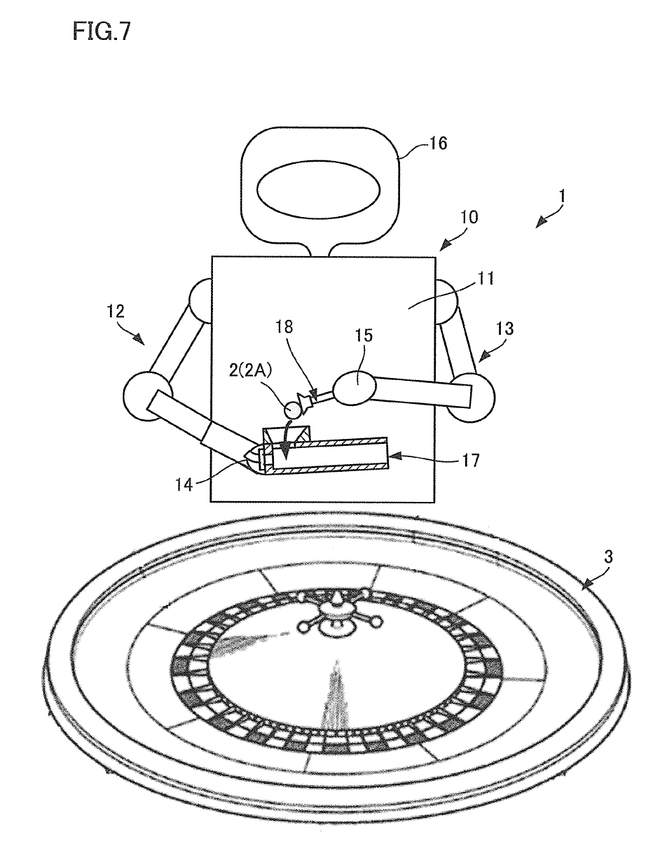

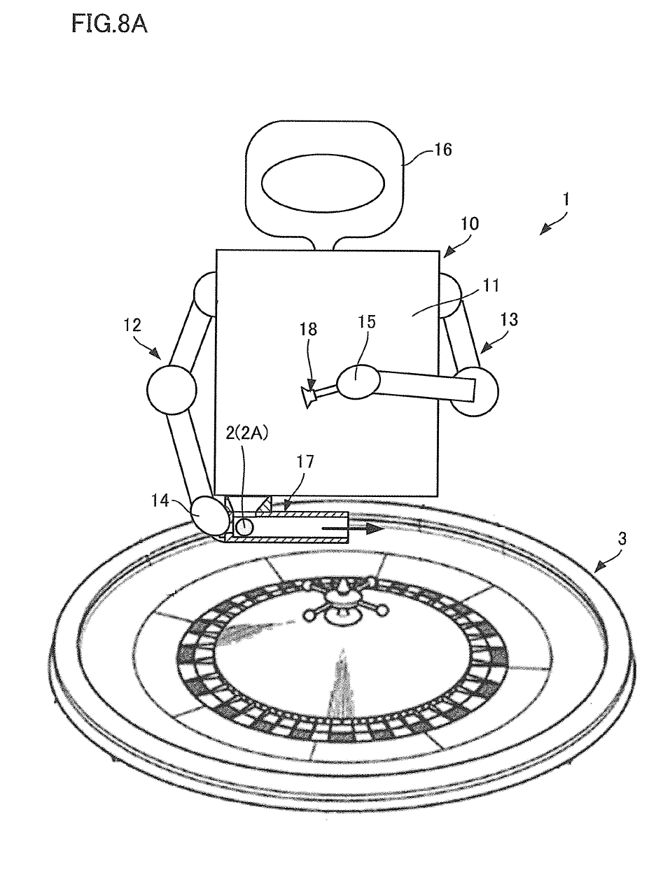

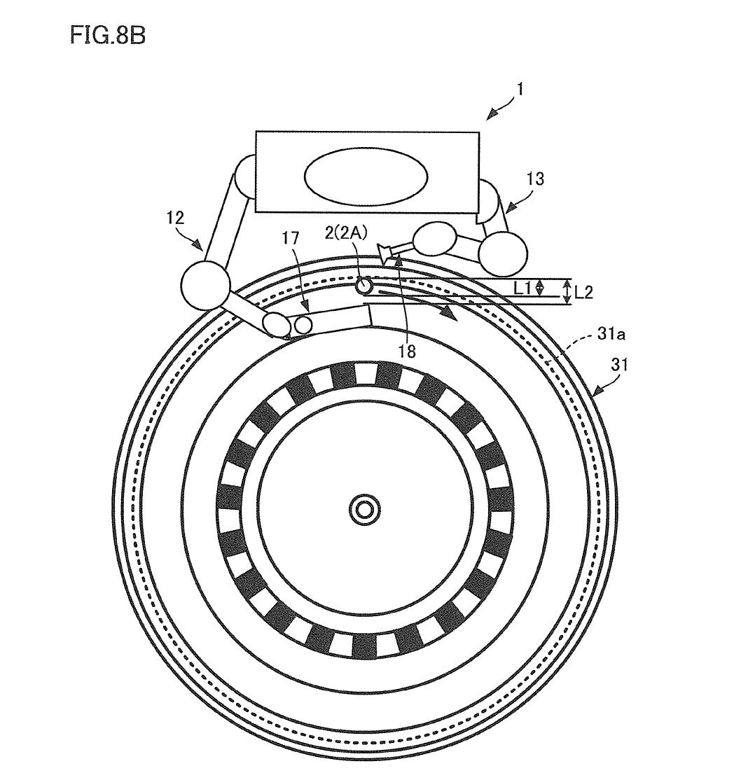

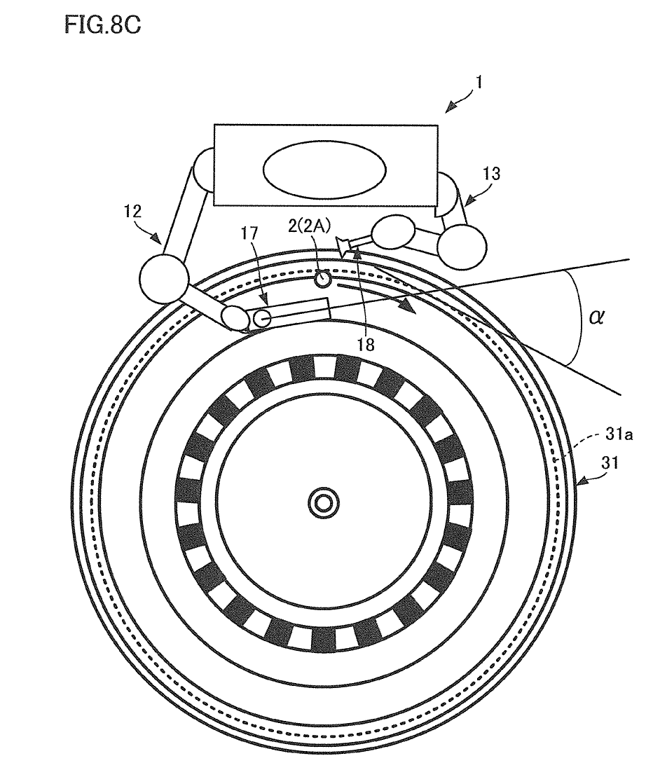

To be more specific, the controller 6 is configured to control the trunk 11, the arms 12 and 13, the shooting mechanism 17, and the holding mechanism 18 so as to perform a greeting motion of FIG. 4, a standby motion of FIG. 5, an attraction motion of FIG. 6, a transfer motion of FIG. 7, and a discharge motion of FIG. 8A.

In the greeting motion of FIG. 4, the robotic device 10 performs the following effect operation: the robotic device 10 turns the trunk 11 to face the player, bows by lowering the head 16, and waves the first handling portion 14 of the right arm 12 with the first handling portion 14 raised. In the standby motion of FIG. 5, the first handling portion 14 of the right arm 12 and the second handling portion 15 of the left arm 13 are moved to positions in front of a middle portion of the trunk 11, and the arms take this standby posture until the wheel having the roulette ball 2A as the gaming tool 2 thereon stops. In the attraction motion of FIG. 6, the second handling portion 15 of the left arm 13 in the standby posture of FIG. 5 is moved downward so that a leading end portion of the holding mechanism 18 comes into contact with the roulette ball 2A on the wheel, and then suction is performed using the air compressor 72 with the leading end portion of the holding mechanism 18 being in contact with the roulette ball 2A, to attract the roulette ball 2A onto the holding mechanism 18.

In the transfer motion of FIG. 7, the first handling portion 14 of the right arm 12 in the standby posture is moved upward, and the leading end portion of the shooting mechanism 17 is raised. Thereafter, the second handling portion 15 of the left arm 13 is raised, and the leading end portion of the holding mechanism 18 is moved to a position above the shooting mechanism 17. Then, the roulette ball 2A is dropped into the shooting mechanism 17 from the holding mechanism 18 by stopping the suction in the holding mechanism 18. In the discharge motion of FIG. 8A, the first handling portion 14 of the right arm 12 is lowered to move the shooting mechanism 17 accommodating the roulette ball 2A to a position in the vicinity of the roulette wheel, and in this state, compressed air is ejected from the shooting mechanism 17 to discharge the roulette ball 2A to the roulette wheel.

FIG. 8B shows the positional relationship between the shooting mechanism 17 of the first handling portion 14 and the roulette wheel 31 in the discharge motion of FIG. 8A. To be more specific, in the discharge motion of FIG. 8A, a shortest distance L2 between the leading end portion of the shooting mechanism 17 and an inner circumferential wall 31a of the roulette wheel 31, in contact with which the roulette ball 2A spins, is set to be larger than a diameter L1 of the roulette ball 2A. This structure allows the roulette ball 2A to run through a gap between the shooting mechanism 17 and the inner circumferential wall 31a when the roulette ball 2A shot from the shooting mechanism 17 spins in contact with the inner circumferential wall 31a of the roulette wheel 31, and therefore the shooting mechanism 17 does not interfere with the spinning of the roulette ball 2A. This eliminates the necessity for quickly moving the shooting mechanism 17 to a position at which the shooting mechanism 17 does not interfere with the roulette ball 2A after shooting of the roulette ball 2A from the shooting mechanism 17 of the first handling portion 14 and before the roulette ball 2A travels a lap of the track along the inner circumferential wall 31a. The smaller the diameter of the inner circumferential wall 31a is, the shorter the time required for the roulette ball 2A to run a lap of the track on the roulette wheel 31 is. Thus, the above structure is more effective in such a case. That is, if the diameter of the roulette wheel 31 is small, it is necessary to use a high-performance motor providing a high operation speed in order to retract the shooting mechanism 17 immediately after the shooting of the roulette ball 2A. In this regard, by providing the gap through which the roulette ball 2A passes, the shooting mechanism 17 does not interfere with the spinning of the ball 2A advantageously, even if the retraction of the shooting mechanism 17 takes time. It is desirable that the right arm 12 remains at this position while ejecting compressed air until the roulette ball 2A runs a plurality of laps on the roulette wheel 31. In this arrangement, the spinning speed of the roulette ball 2A is adjustable by the compressed air. Further, as shown in FIG. 8C, it is preferable that the ball is discharged from a nozzle of the shooting mechanism 17 toward the inner circumferential wall 31a, and a line along the direction of discharge is at a predetermined angle α to a line segment of a tangent to the inner circumferential wall 31a at the intersection. The angle α is an acute angle, which is an angle less than 90 degrees. After this operation, the right arm 12 and the left arm 13 are set to have the standby postures of FIG. 5. These operations will be detailed later with reference to flowcharts.

(Shooting Mechanism 17)

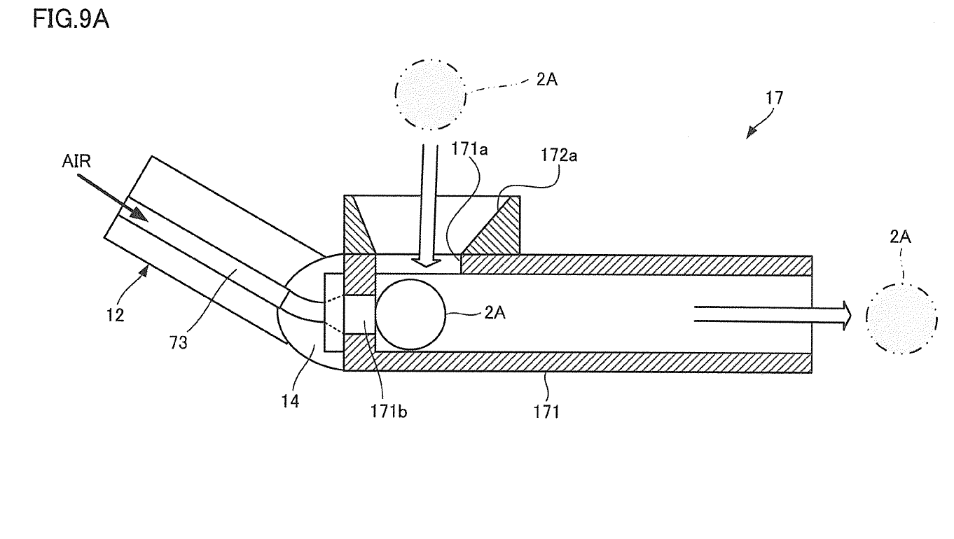

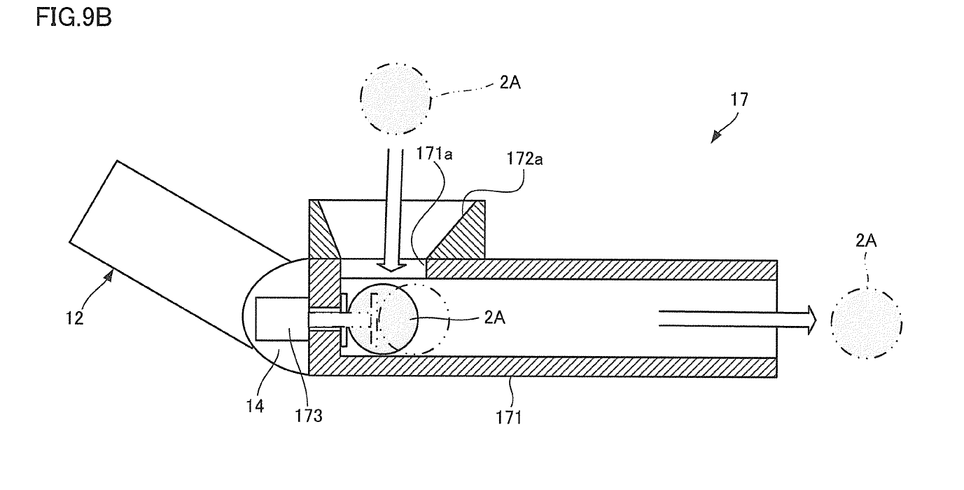

As shown in FIG. 9A, the shooting mechanism 17 is configured to discharge the roulette ball 2A, by pushing the ball 2A by compressed air. This configuration of the shooting mechanism 17 eliminates the necessity for moving the right arm 12 at the time of moving the roulette ball 2A, to simplify the control of the right arm 12.

To be more specific, the shooting mechanism 17 has a tubular shape body 171 capable of accommodating the roulette ball 2A. One end portion of the tubular shape body 171, which is on a fixed end side, is fixed to the first handling portion 14 of the right arm 12. A through hole 171b is formed through the wall of the one end portion of the tubular shape body 171. The through hole 171b is connected to the air compressor 72 of FIG. 1 through an air tube 73, and this enables the compressed air to enter into the tubular shape body 171 from the air compressor 72. Meanwhile, an end of the tubular shape body 171 on a free end side is open, which enables the roulette ball 2A to pass therethrough. Thus, the shooting mechanism 17 is configured to push the roulette ball 2A accommodated in the tubular shape body 171 by the compressed air entering through the through hole 171b on the one end side, thereby to discharge the roulette ball 2A through the opening on the other end side. This configuration eliminates the necessity for moving the right arm 12 to discharge the ball 2A.

Through the periphery of the tubular shape body 171, there is formed a reception hole 171a through which the roulette ball 2A is received into the tubular shape body 171. Above the reception hole 171a, a guide member 172 is provided. The guide member has a guide hole 172a penetrating the guide member 172 from its bottom closer to the tubular shape body 171 to the top of the guide member 172. The lower end of the guide hole 172a matches the reception hole 171a near the tubular shape body 171. The guide hole 172a is shaped to have the diameter increasing from its lower end to its upper end so that the diameter of the opening on the upper surface is the largest. This configuration of the shooting mechanism 17 makes it possible to easily transfer the roulette ball 2A to the tubular shape body 171 when the accuracy in positioning and/or transfer of the roulette ball 2A is low.

Note that the present embodiment is described using the shooting mechanism 17 which employs compressed air, as shown in FIG. 9B; however, the shooting mechanism is not limited to this. The shooting mechanism 17 may include a plunger device 173 provided at the one end portion of the tubular shape body 171 on the fixed end side, and may be configured to shoot the roulette ball 2A by pushing the ball 2A using the plunger device 173. Alternatively, the shooting mechanism 17 may be configured to shoot the roulette ball 2A by pushing the ball 2A using the plunger device 173 and using the compressed air. In this case, the speed of the roulette ball 2A is adjustable by controlling the pneumatic pressure of the compressed air and the force applied by the plunger device 173, and this enables adjustment at multiple stages.

(Holding Mechanism 18)

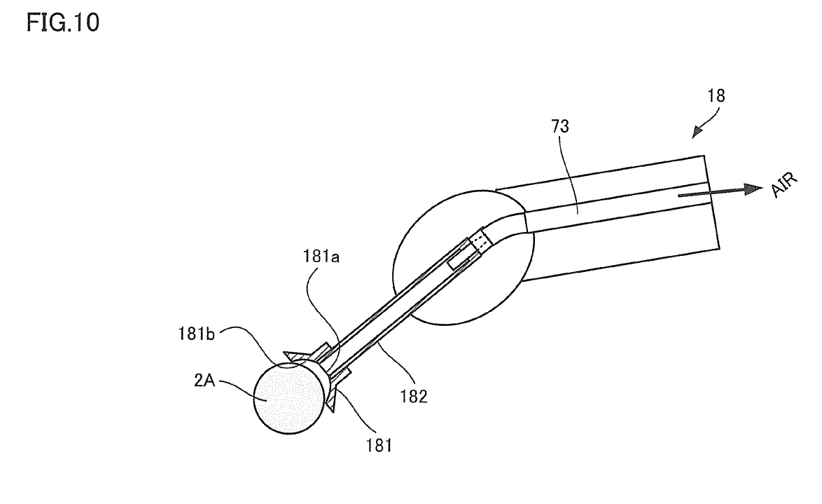

As shown in FIG. 10, the holding mechanism 18 is configured to be capable of holding the roulette ball 2A. To be more specific, the holding mechanism 18 includes: a sucker 181 configured to make surface contact with the roulette ball 2A; and a tubular member 182, at a leading end of which the sucker 181 is provided. The tubular member 182 is connected to the air compressor 72 (air suction device) in FIG. 3. The sucker 181 has a sucker surface 181b configured to make surface contact with the roulette ball 2A. The sucker 181 further has a suction opening 181a which opens onto the sucker surface 181b. The suction opening 181a is connected to the air compressor 72 (air suction device) in FIG. 3 through the tubular member 182 and the like. A portion of the sucker 181 which is contacts the roulette ball 2A is made of elastomer.

Thus, the sucker 181, the part of the holding mechanism 18 which contacts the roulette ball 2A, is made of elastomer, and therefore the sucker 181 has a function of absorbing a shock. This makes it less likely that the roulette ball 2A and the holding mechanism 18 are damaged as a result of abrupt application of a load to the roulette ball 2A when the holding mechanism 18 is brought into contact with the roulette ball 2A.

Note that the holding mechanism 18 may be arranged as follows. The holding mechanism 18 may include a magnet mechanism configured to generate magnetism by energizing an induction coil. In this case, the roulette ball 2A may also be arranged to have iron powder or iron foil so as to be attractable by the magnetic energy. With this, attraction and release of the roulette ball 2A is controllable by turning on/off the energization of the induction coil.

(Robot Controller 61, Host Controller 62)

The above-described dealer substitute device 1 is structured so that all the operations of the dealer substitute device 1 including the robotic device 10 are controlled by a single control system structured by the single controller 6; however, the present invention is not limited to this. That is to say, the functions and parts of the dealer substitute device 1 may be controlled by a plurality of control systems.

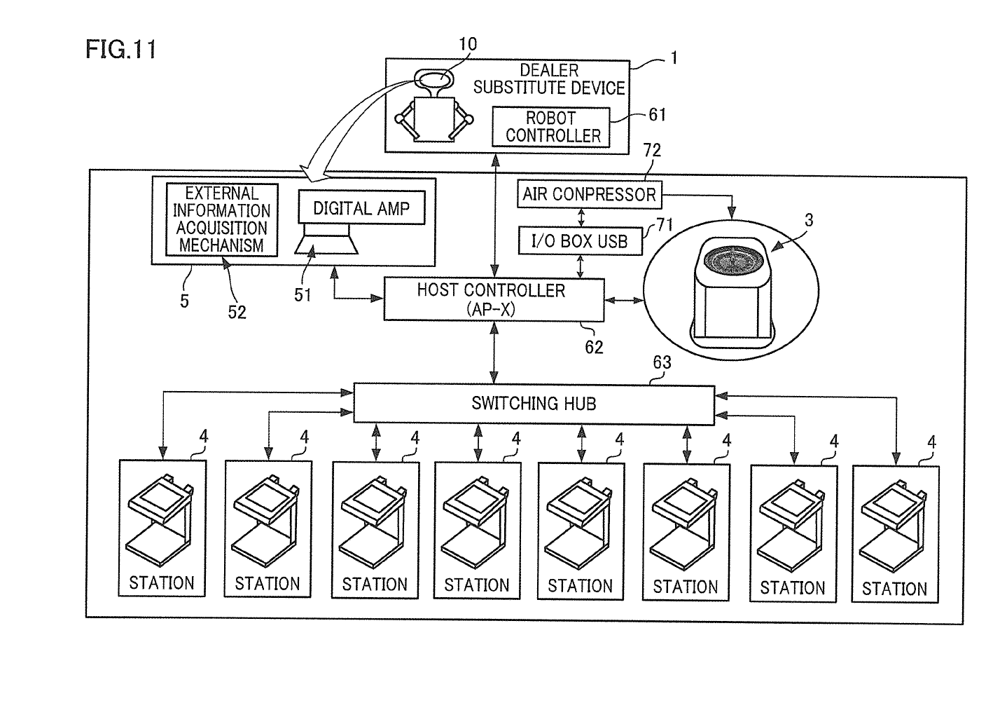

For example, as shown in FIG. 11, the dealer substitute device 1 may be configured to handle the roulette ball 2A which is the gaming tool used in a game, and may include: a host controller 62 (first controller) configured to exercise control related to handling of the gaming tool 2; and a robot controller 61 (second controller) used for posture control for the effect operation of the robot. In the above arrangement, the control related to the handling of the roulette ball 2A is exercised by the host controller 62; and the posture control for the effect operation of the robotic device 10 is exercised by the robot controller 61. With this, stability of the game is improved as compared with the case where control is made by a single controller. In the present embodiment, the robot controller 61 is used for the posture control for the effect operation of the robot, based on the control related to the handling of the gaming tool 2 exercised by the host controller 62; however, the present invention is not limited to this. For example, the robot controller 61 may be used irrespective of the control related to the handling of the gaming tool 2 exercised by the host controller 62. That is, the robot controller 61 and the host controller 62 may be used for the robot independently from each other. In other words, the single robot may be controlled by the robot controller 61 and the host controller 62 which are independent from each other.

To be more specific, the controllers may be arranged such that: the host controller 62 is capable of executing the process of instructing the robot controller 61 about the postures of the arms 12 and 13 and the trunk 11 to perform the effect operation; and the robot controller 61 is capable of executing the process of controlling the arms 12 and 13 and the trunk 11 based on the instruction from the host controller 62. In this arrangement, the host controller 62 and the robot controller 61 control the arms 12 and 13 and the trunk 11 to move similarly to the arms and the trunk of a dealer. With this, a gaming environment further resembling the atmosphere in which a human dealer handles the gaming tool 2 is provided to the player.

The host controller 62 may be arranged to be capable of controlling the communication mechanism 5. That is, the host controller 62 may execute the process of: obtaining player information based on the image of the player acquired by the camera mechanism which is the external information acquisition mechanism 52 and based on the sound of the player acquired by the microphone mechanism, and then outputting response information corresponding to the player information through the speaker mechanism of the information output mechanism 51. In this arrangement, communication with the player is conducted by the host controller 62 through the acquisition of the image and sound and through the output. With this, a gaming environment further resembling the atmosphere in which a human dealer handles the gaming tool 2 is provided to the player. As such, the host controller 62 is capable of controlling the communication mechanism 5 configured to acquire the player information and to output the response information in the present embodiment; however, the present invention is not limited to this. For example, another independent controller may be provided to control the communication mechanism. Alternatively, the communication mechanism may include a controller configured to execute the function of communication.

The host controller 62 may be connected to the I/O box 71 to be capable of controlling the air compressor 72. The air compressor 72 is connected to the shooting mechanism 17 of the first handling portion 14 and the holding mechanism 18 of the second handling portion 15 via the air tubes which are not illustrated. The air compressor 72 is capable of discharging compressed air and sucking air. The host controller 62 may be configured to control the air control valve of the air compressor 72 through the I/O box 71 so as to have the shooting mechanism 17 and the holding mechanism 18 operate at respective predetermined timings, thereby to perform operation of handling the gaming tool 2, in association with the motion of the trunk 11 and the arms 12 and 13.

The thus structured host controller 62 may be connected to a plurality of terminal devices 4 via a switching hub 63. In this arrangement, the host controller 62 has a function of obtaining various types of game information such as bet information and credit information from each terminal device 4, and performing payout process of awarding a payout based on a game result and settlement process to each terminal device 4.

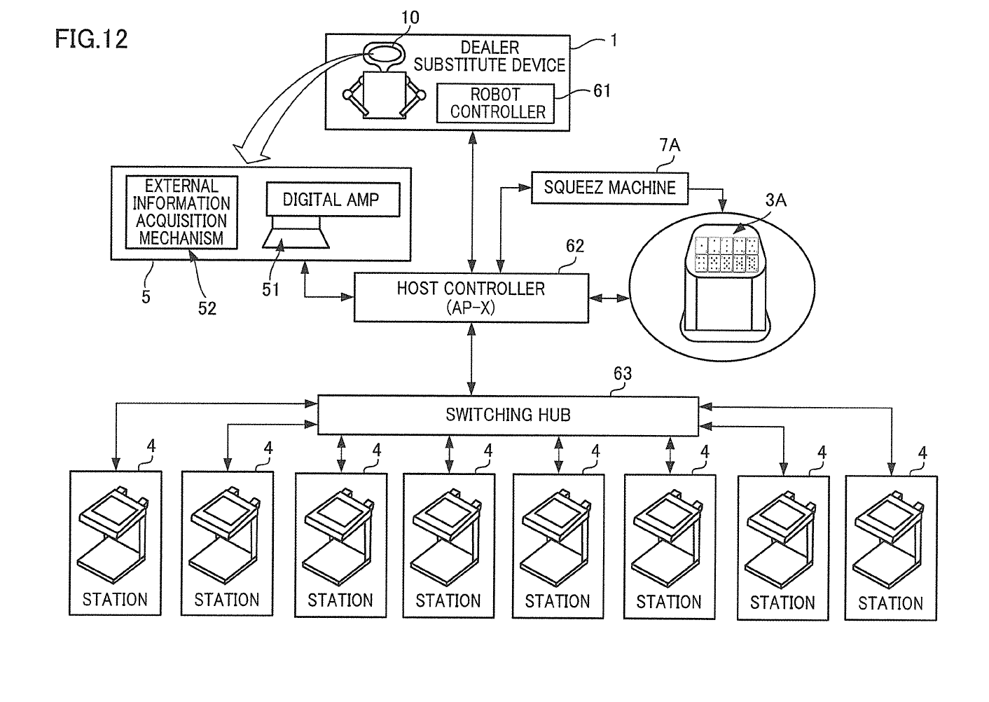

Thus, the dealer substitute device 1 has the robot controller 61 and the host controller 62 which are separated from each other, and this makes it possible to easily configure a gaming system for a roulette game constituted by the combination of the roulette apparatus 3 and the terminal devices 4. For example, by replacing the roulette apparatus 3, the air compressor 72, and the I/O box 71 with a card game apparatus 3A and a squeeze machine 7A, as shown in FIG. 12, a gaming system for a card game is configured.

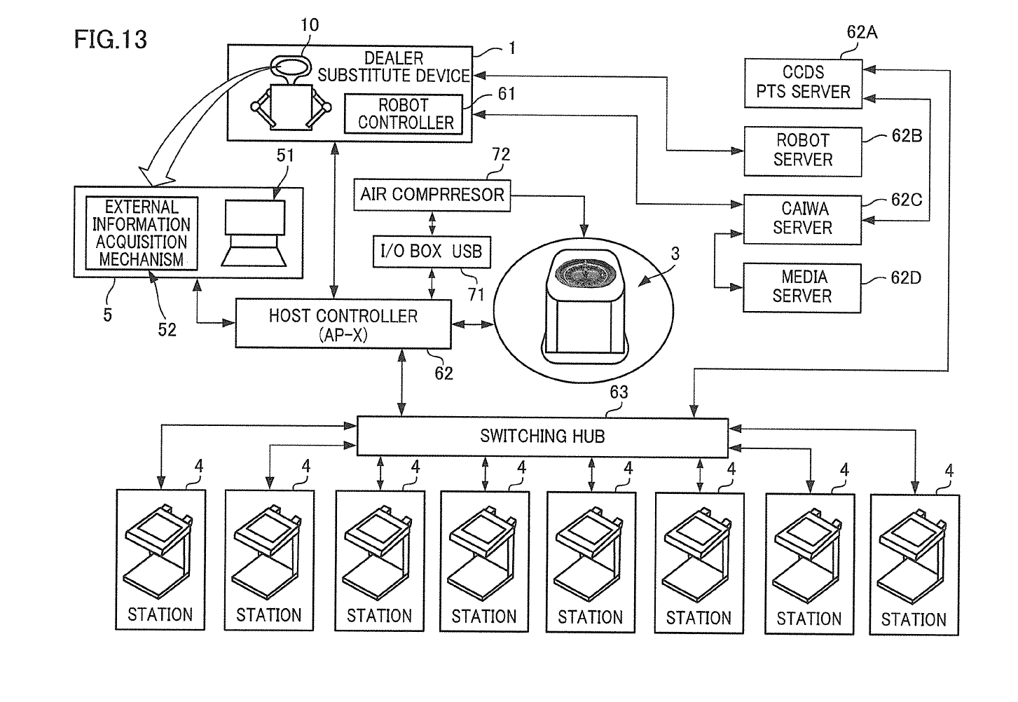

In the gaming system of FIG. 11, the control on the communication mechanism 5 is made by the host controller 62; however, the present invention is not limited to this. For example, as shown in FIG. 13, a gaming system for a roulette game may be configured to include specific servers of: a PTS server 62A, a robot server 62B, a CAIWA (c) server 62C, and a media server 62D, which are respectively specialized in specific processing and combined with each other.

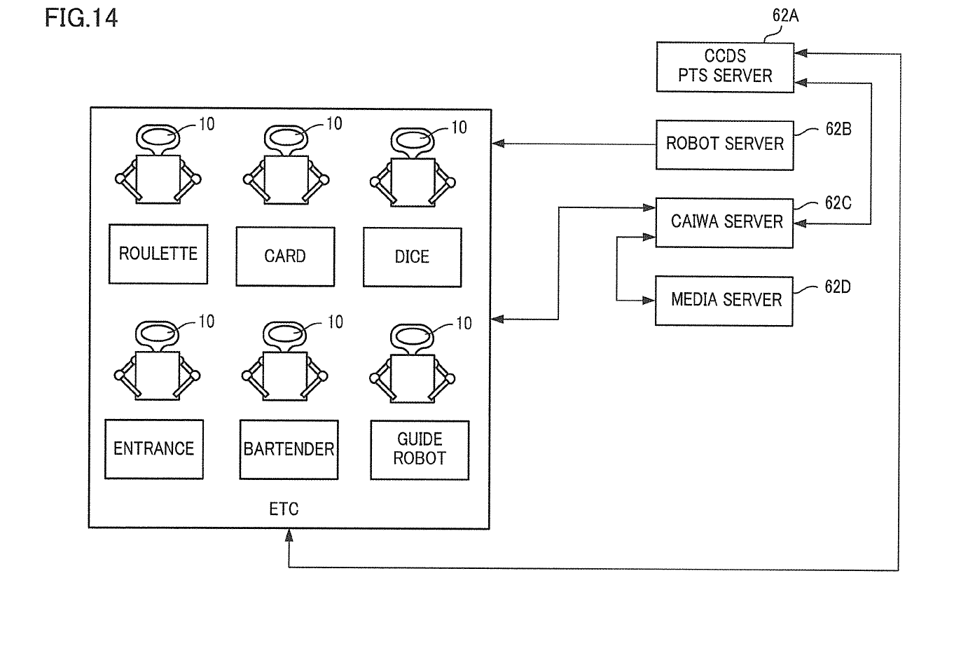

Further, as shown in FIG. 14, various types of processing information may be stored in the robot server 62B and the CAIWA server 62C so that a plurality of robotic devices 10 respectively perform different types of processes. In this case, for example, most of jobs in a casino hall can be done by the robotic devices 10. To be more specific, it is possible to control the robotic devices 10 so that: the robotic device 10 positioned at an entrance executes the process of functioning as a receptionist; the robotic device 10 positioned at a bar counter executes the process of functioning as a bartender; and the robotic device 10 positioned at an information center executes the process of functioning as an information clerk. Further, each of the robotic devices 10 respectively positioned at a roulette apparatus for a roulette game, a card apparatus for a card game, and a dice apparatus for a dice game is controlled to execute the process of functioning as a dealer of the corresponding game.

Note that the above system in which the one or more robotic devices 10 are used in the casino hall is merely an example. The robotic devices 10 may be positioned at kiosks of train or bus stations, for example, and the robotic device 10 at each kiosk may be controlled from a server provided in a central monitoring station so as to execute the process of functioning as a store personnel. Alternatively, the robotic device 10 may be positioned at the reception of a hotel, hospital, company, or restaurant, to execute the process of functioning as a receptionist.

(Electrical Structure of Dealer Substitute Device 1)

The following will describe, in detail, the electrical structure of the dealer substitute device 1 arranged to be controlled by the plurality of control systems.

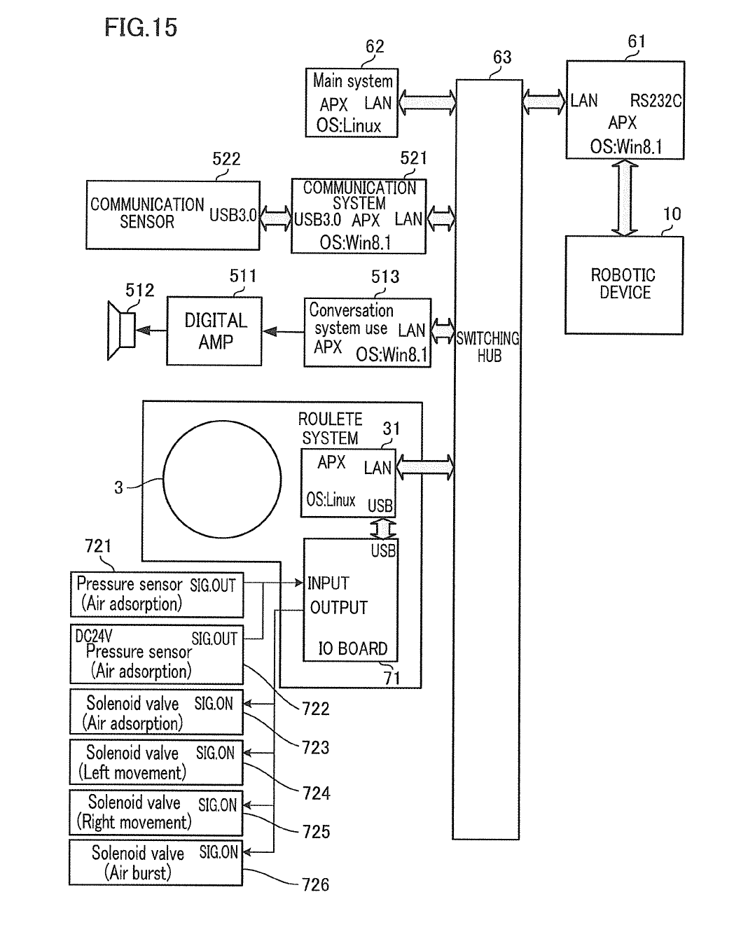

As shown in FIG. 15, the dealer substitute device 1 includes: the robot controller 61 configured to control the operation of the robotic device 10; and the host controller 62 configured to control the operation other than the operation of the robotic device 10. As the robot controller 61, an embedded board which operates on the OS (operating system) of Windows (registered trademark) 8.1 is employed, for example. As the host controller 62, an embedded board which operates on the OS (operating system) of Linux (registered trademark) is employed, for example.

The host controller 62 is connected with a control system for the communication mechanism 5 and with a control system for the roulette apparatus 3 via the switching hub 63. The communication mechanism 5 includes: a communication system controller 521; and a communication sensor 522, such as a CCD sensor, connected to the communication system controller 521. As the communication system controller 521, an embedded board which operates on the OS (operating system) of Windows 8.1 is employed, for example.

The communication mechanism 5 further includes: a conversation system controller 513; a digital amplifier 511 connected to the conversation system controller 513; and a speaker 512 connected to the digital amplifier 511. As the conversation system controller 513, an embedded board which operates on the OS (operating system) of Windows 8.1 is employed, for example.

The host controller 62 is connected with the control system for the roulette apparatus 3, which is a gaming machine, via the switching hub 63. The roulette apparatus 3 includes: a roulette controller 31; the I/O box 71 connected to the roulette controller 31; and the air compressor 72 connected to the I/O box 71. As the roulette controller 31, an embedded board which operates on the OS (operating system) of Linux is employed, for example. The air compressor 72 has pressure sensors 721 and 722 respectively provided in two signal paths, and solenoid valves 723, 724, 725, and 726 respectively provided in four piping paths. The solenoid valve 723 is used for suction of air. The solenoid valve 724 is used for leftward movement. The solenoid valve 725 is used for rightward movement. The solenoid valve 726 is used at the time of ejection of compressed air.

(Electrical Structure of Robotic Device 10)

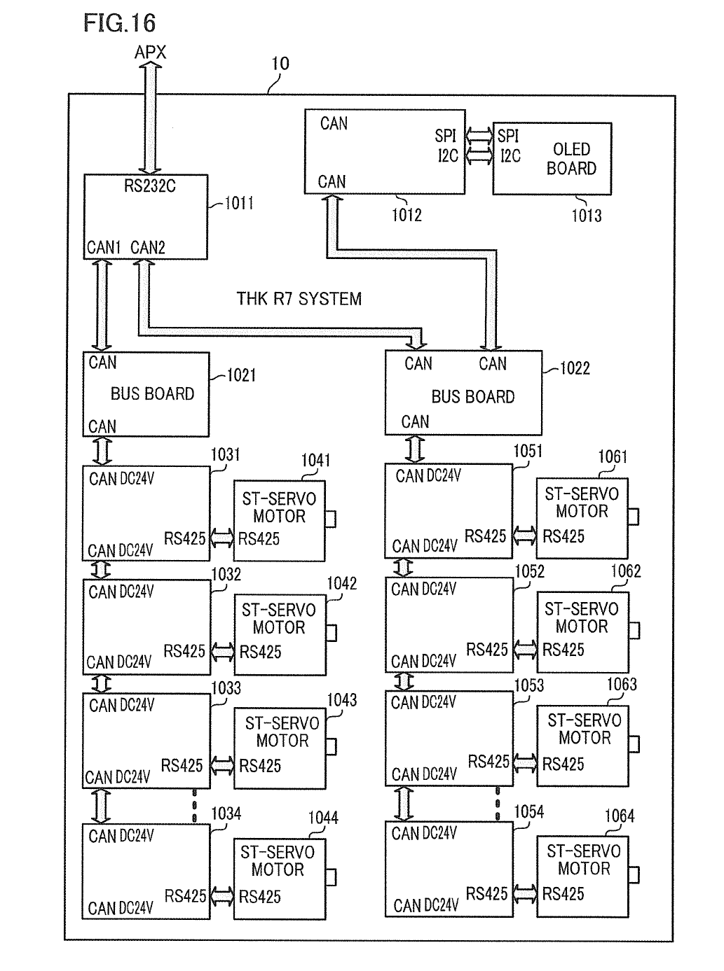

As shown in FIG. 16, the robotic device 10 has a servo control board 1011 connected to the robot controller 61. The servo control board 1011 is connected to a bus-board 1021. The bus-board 1021 is connected to servo drive boards 1031 to 1034 for driving respective servo motors 1041 to 1044 which drive axes of the right arm 12 and the like. The servo control board 1011 is also connected to a bus-board 1022. The bus-board 1022 is connected to servo drive boards 1051 to 1054 for driving respective servo motors 1061 to 1064 which drive axes of the left arm 13 and the like.

(Detailed Operation of Dealer Substitute Device)

The following will describe, in detail, the operation of the dealer substitute device 1 in the gaming system of FIG. 15 and FIG. 11. The following description deals with the case where: the host controller 62 has an operation flag table storing therein operation flags each indicating the state of corresponding one of the various processing operations; and the host controller 62, the robot controller 61, and the roulette controller 31 cooperate with one another to exercise control by monitoring the operation flags.

The above-described cooperative control may be exercised in a way other than the way of monitoring of the operation flags. For example, the control may be exercised by transmitting a signal from the host controller 62 to the robot controller 61 and/or the roulette controller 31, the signal indicating operation identification information for triggering the operation of the robot controller 61 and/or the roulette controller 31 and indicating the timing of the operation. Alternatively, the control may be exercised by transmitting a command signal and responding thereto among the host controller 62, the robot controller 61, and the roulette controller 31 about the status of processing, to exchange communication among them.

(Detailed Operation of Dealer Substitute Device: Operation Flag Table)

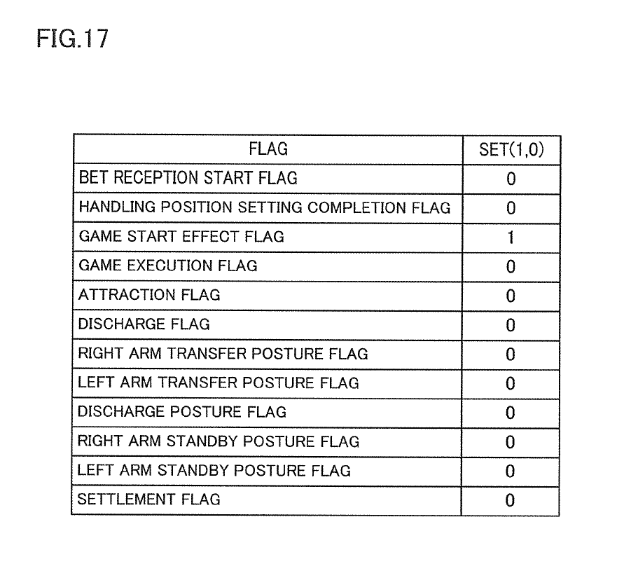

As shown in FIG. 17, the operation flag table has a flag column and a setting value column. The flag column stores the variety of operation flags. In the setting value column, the flag setting of each operation flag is indicated with “1 (set)” and “0 (not set)”.

To be more specific, the operation flag include: a bet reception start flag: a handling position setting completion flag; a game start effect flag; a game execution flag; an attraction flag; a discharge flag; a right arm transfer posture flag; a left arm transfer posture flag; a discharge posture flag; a right arm standby posture flag; a left arm standby posture flag; and a settlement flag.

The bet reception start flag set to “1” indicates that the reception of a bet is available. The handling position setting completion flag set to “1” indicates that the roulette ball 2A on the wheel has been moved to a handling position at which the roulette ball 2A is able to be held by the holding mechanism 18 of the robotic device 10. The game start effect flag set to “1” indicates the start of a game. The game execution flag set to “1” indicates that the game is being executed.

The attraction flag set to “1” indicates that the holding mechanism 18 is attracting the roulette ball 2A thereon. The discharge flag set to “1” indicates that the shooting mechanism 17 has discharged the roulette ball 2A. The right arm transfer posture flag set to “1” indicates that the right arm 12 has entered into the posture in which the shooting mechanism 17 accepts the roulette ball 2A. The left arm transfer posture flag set to “1” indicates that the left arm 13 has entered into the posture in which the roulette ball 2A on the holding mechanism 18 is transferred to the shooting mechanism 17. The discharge posture flag set to “1” indicates that the right arm 12 has moved to a predetermined position above the roulette wheel. The right arm standby posture flag set to “1” indicates that the right arm 12 is in the standby posture. The left arm standby posture flag set to “1” indicates that the left arm 13 is in the standby posture. The settlement flag set to “1” indicates that the player who has finished the game is settling the game result.

(Detailed Operation of Dealer Substitute Device: Main Process)

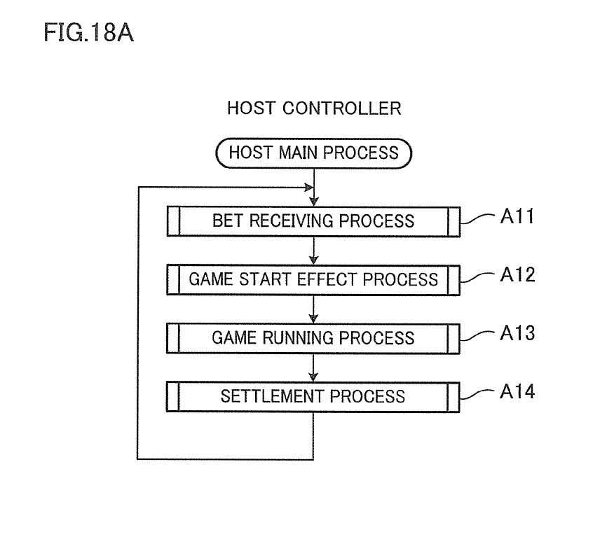

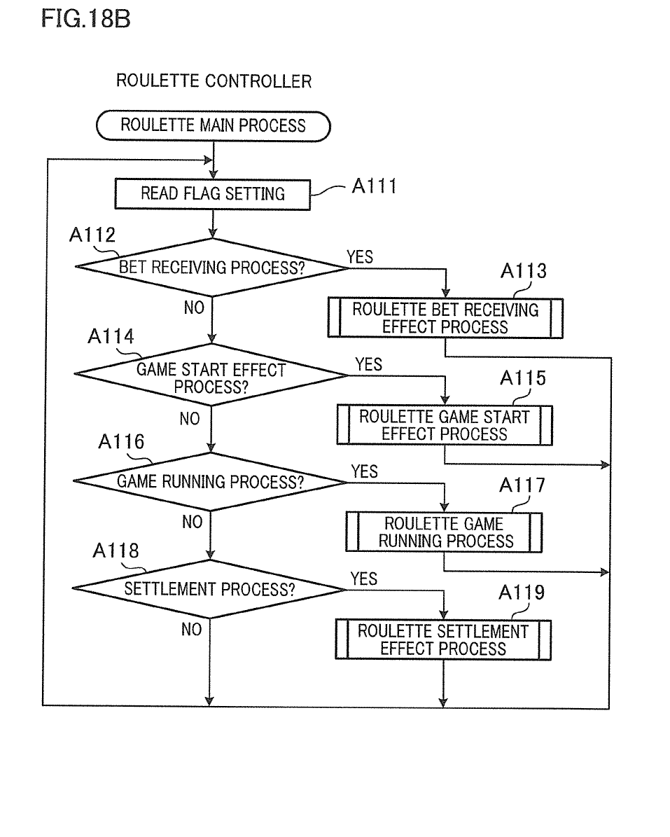

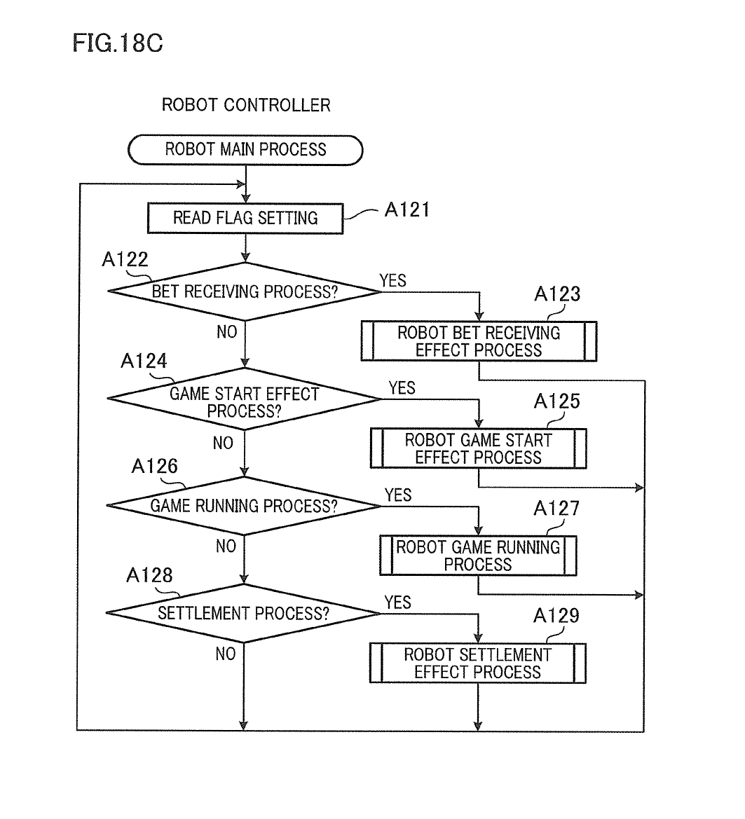

The following describes the main process, with reference to FIG. 18A to FIG. 18C. FIG. 18A shows the main process in the host controller 62, FIG. 18B shows the main process in the roulette controller 31, and FIG. 18C shows the main process in the robot controller 61.

As shown in FIG. 18A, in the host controller 62, a bet receiving process (A11), a game start effect process (A12), a game running process (A13), and a settlement process (A14) are executed, sequentially. The details of each process will be described later.

As shown in FIG. 18B, in the roulette controller 31, the setting of the operation flag is read from the operation flag table of FIG. 17 (A111). Then, the current operation state is determined based on the operation flag.

To be more specific, it is determined whether the bet receiving process is being executed (A112). When the bet receiving process is being executed (A112: YES), a roulette bet receiving effect process is executed (A113). Meanwhile, when the bet receiving process is not being executed (A112: NO), it is determined whether the game start effect process is being executed (A114). When the game start effect process is being executed (A114: YES), a roulette game start effect process is executed (A115). Meanwhile, when the game start effect process is not being executed (A114: NO), it is determined whether the game running process is being executed (A116).

When the game running process is being executed (A116: YES), a roulette game running process is executed (A117). Meanwhile, when the game running process is not being executed (A116: NO), it is determined whether the settlement process is being executed (A118). When the settlement process is being executed (A118: YES), a roulette settlement effect process is executed (A119). When the settlement process is not being executed (A118: NO), this routine is executed again from A111.

As shown in FIG. 18C, in the robot controller 61, the setting of the operation flag is read from the operation flag table of FIG. 17 (A121). Then, the current operation state is determined based on the operation flag.

To be more specific, it is determined whether the bet receiving process is being executed (A122). When the bet receiving process is being executed (A122: YES), a robot bet receiving effect process is executed (A123). Meanwhile, when the bet receiving process is not being executed (A122: NO), it is determined whether the game start effect process is being executed (A124). When the game start effect process is being executed (A124: YES), a robot game start effect process is executed (A125). Meanwhile, when the game start effect process is not being executed (A124: NO), it is determined whether the game running process is being executed (A126).

When the game running process is being executed (A126: YES), the robot game running process is executed (A127). Meanwhile, when the game running process is not being executed (A126: NO), it is determined whether the settlement process is being executed (A128). When the settlement process is being executed (A128: YES), a roulette settlement effect process is executed (A129). When the settlement process is not being executed (A128: NO), this routine is executed again from A121.

(Detailed Operation of Dealer Substitute Device: Bet Receiving Process)

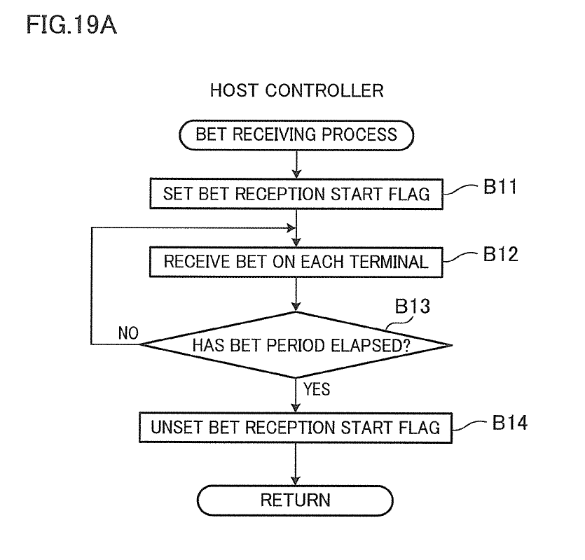

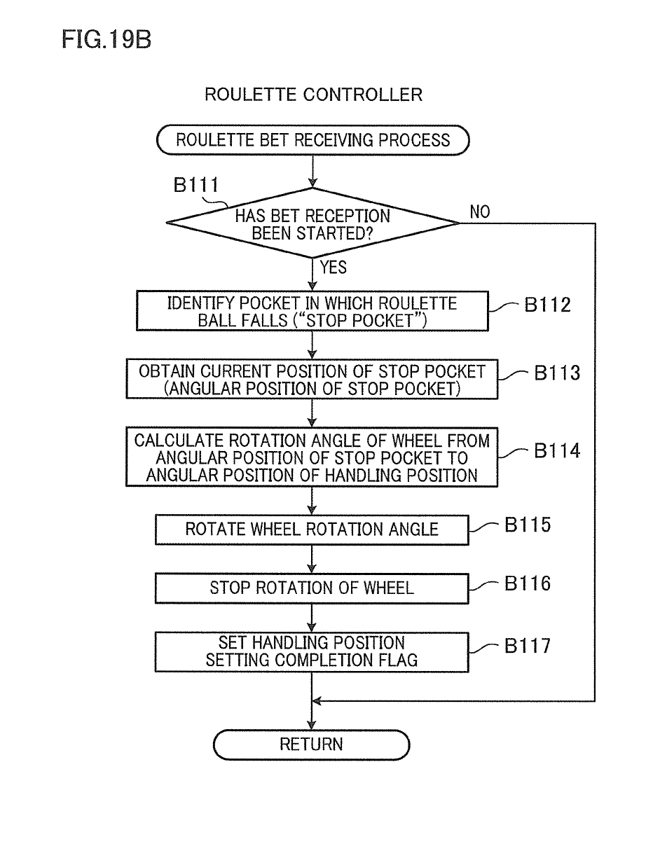

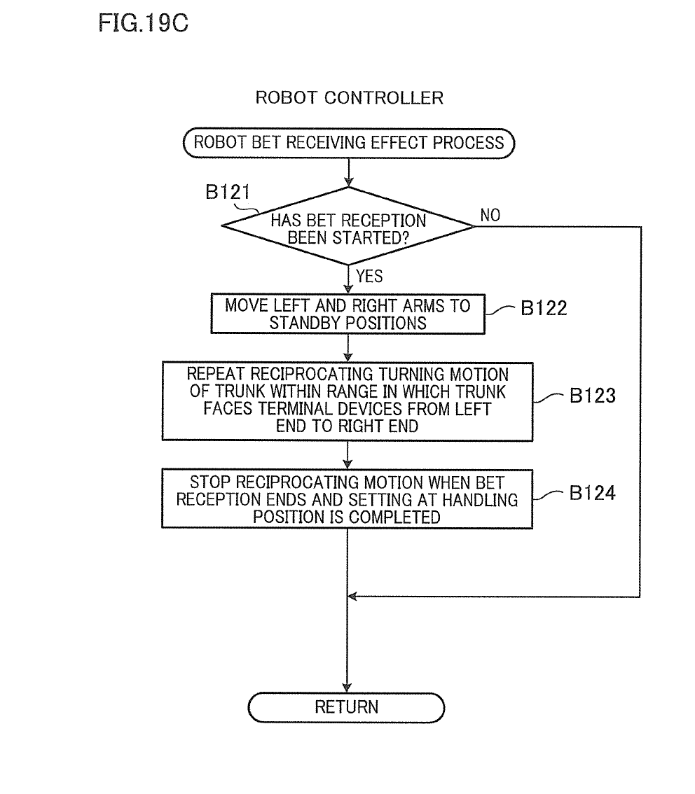

As shown in FIG. 19A, in the host controller 62, setting for the bet reception start flag is made, i.e., the bet reception start flag is set to “1” (B11). Then, the reception of a bet becomes available on each terminal device (B12). It is determined whether a bet period has elapsed (B13), and B12 is executed repeatedly until the bet period has elapsed (B13: NO). When it is determined that the bet period has been elapsed (B13: YES), the bet reception start flag is unset. That is, the bet reception start flag is set to “0” (B14).

As shown in FIG. 19B, in the roulette controller 31, it is determined whether the reception of a bet has been started referring to the bet reception start flag (B111). When the reception of a bet is not started (B111: NO), this routine ends. Meanwhile, when the reception of a bet has been started (B111: YES), a pocket of the wheel in which the roulette ball 2A falls is regarded as a stop pocket (B112). Then, the current position of the stop pocket (stop pocket angular position) is obtained (B113), and a rotation angle from the angular position of the stop pocket to the angular position of the handling position is calculated (A114). Thereafter, the wheel is rotated the thus obtained rotation angle (B115). After the stop pocket is moved to the handling position (FIG. 5), the handling position setting completion flag is set (B118).

As shown in FIG. 19C, in the robot controller 61, it is determined whether the reception of a bet has been started referring to the bet reception start flag (B121). When the reception of a bet is not started (B121: NO), this routine ends. Meanwhile, when the reception of a bet has been started (B121: YES), the right arm 12 and the left arm 13 are moved to their standby positions. Thereafter, the trunk 11 is repeatedly turned left and right so that the trunk 11 faces the terminal device at the left end and the terminal device at the right end within this range (B123). When the bet reception ends and the setting at the handling position is completed, the above reciprocating turning motion of the trunk 11 is stopped (B124).

(Detailed Operation of Dealer Substitute Device: Game Start Effect Process)

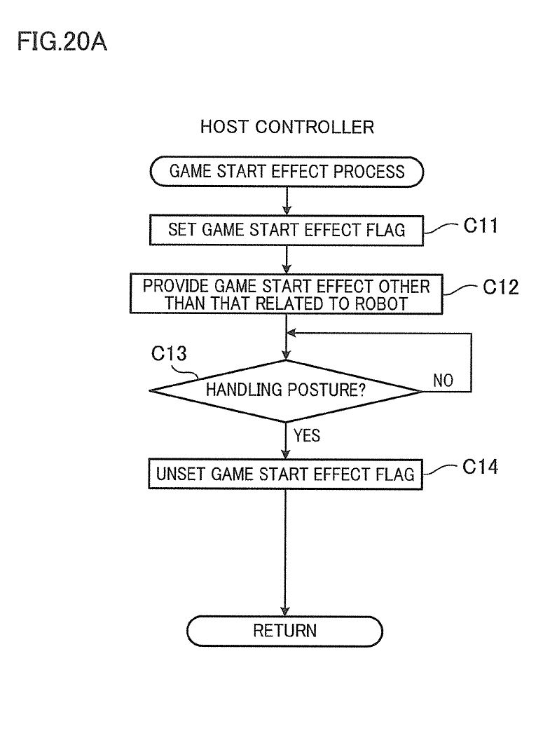

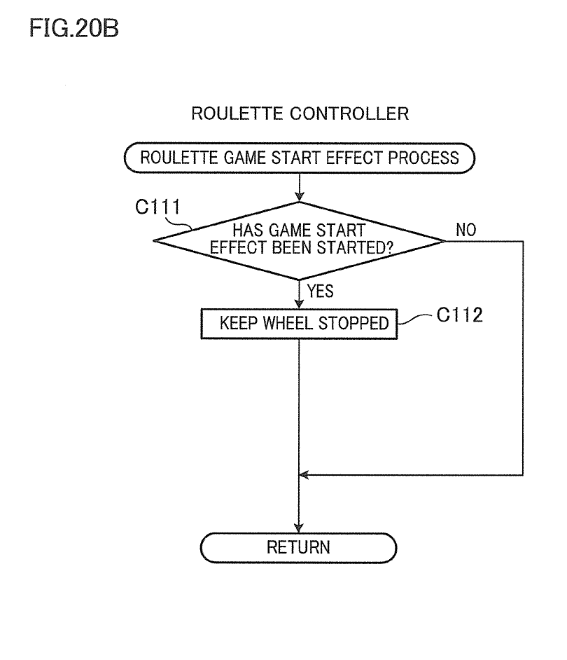

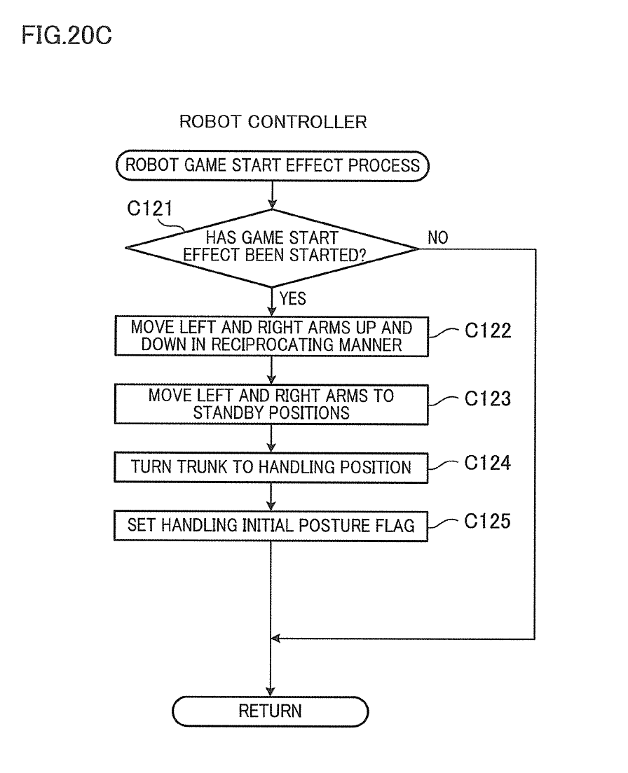

As shown in FIG. 20A, in the host controller 62, the game start effect flag is set (C11). Game start effect other than that related to the robotic device 10 is provided (C12). Then, it is determined whether the robotic device 10 is in a handling posture (C13). When the robotic device is not in the handling posture (C13: NO), C13 is executed again, i.e., the routine waits. When the robotic device takes the handling posture (C13: YES), the game start effect flag is unset (C14).

As shown in FIG. 20B, in the roulette controller 31, it is determined whether the game start effect has been started (C111). When the game start effect is not started (C111: NO), this routine ends. Meanwhile, when the game start effect has been started (C111: YES), the wheel is kept stopped (C112), and this routine ends.

As shown in FIG. 20C, in the robot controller 61, it is determined whether the game start effect has been started (C121). When the game start effect is not started (C121: NO), this routine ends. Meanwhile, when the game start effect has been started (C121: YES), the right arm 12 and the left arm 13 are moved upward and downward in a reciprocating manner (C122). Then, the right arm 12 and the left arm 13 are moved to their standby positions (C123), and the trunk 11 is turned to the handling position (C124). After a handling initial posture flag is set (C125), this routine ends.

### (Detailed Operation of Dealer Substitute Device: Game Running Process)

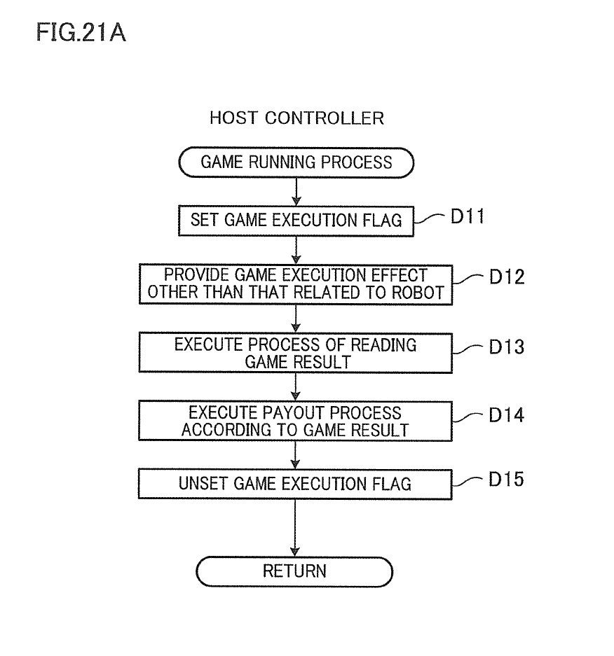

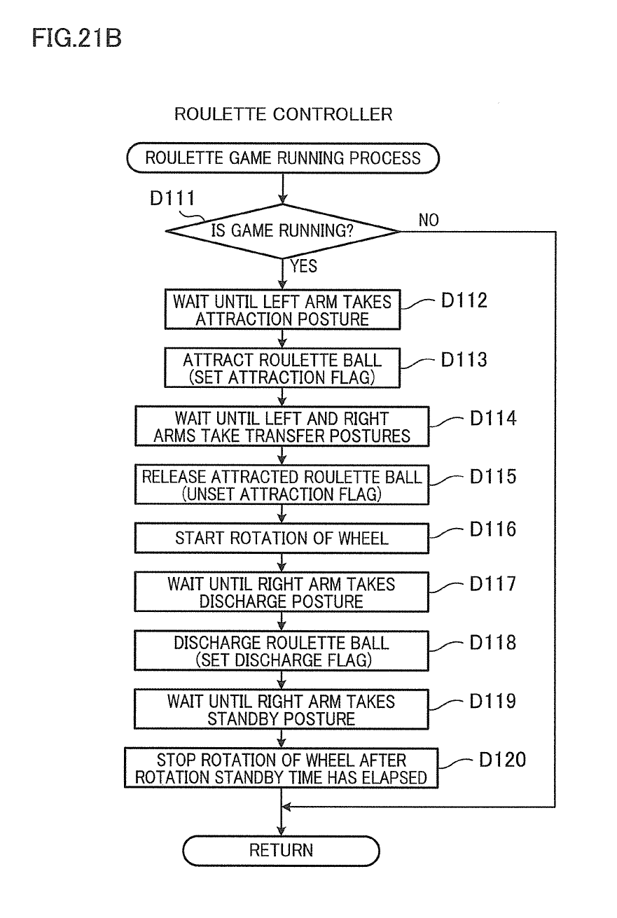

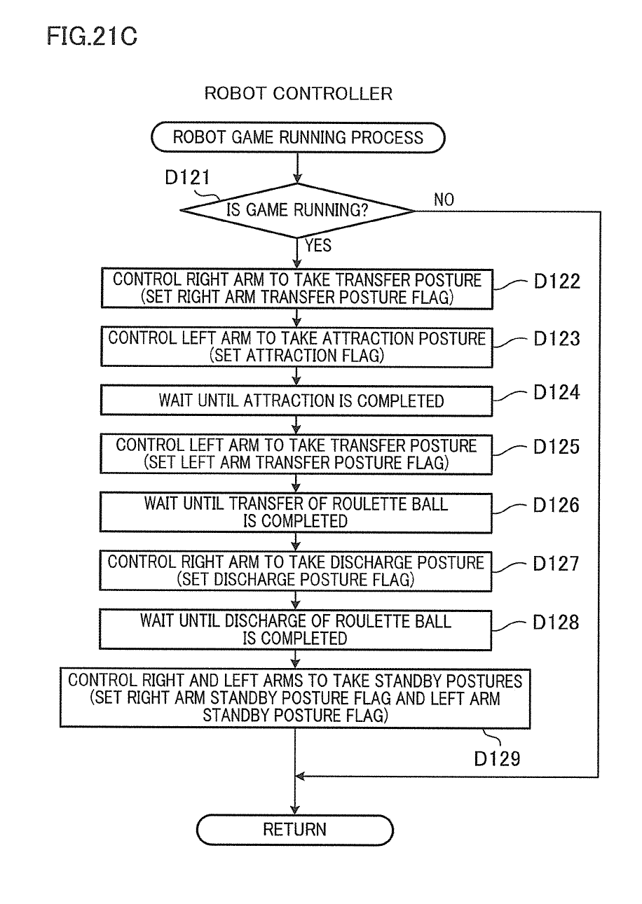

As shown in FIG. 21A, in the host controller 62, the game execution flag is set (D11). Game execution effect other than that related to the robotic device 10 is provided (D12). After a process of reading a game result is executed (D13), a payout process according to the game result is executed (D14). Then, after the game execution flag is unset (D15), this routine ends.

As shown in FIG. 21B, in the roulette controller 31, it is determined whether the game has been started to run (D111). When the game is not started (D111: NO), this routine ends. Meanwhile, when the game is started (D111: YES), the routine waits until the left arm 13 takes an attraction posture shown in FIG. 6. After the left arm takes the attraction posture, the roulette ball 2A is attracted (D113). The routine waits until the left arm 13 and the right arm 12 each takes a transfer posture shown in FIG. 7 (D114).

Then, when the attracted roulette ball 2A is released (D115), rotation of the wheel is started (D116). Then, the routine waits until the right arm 12 takes a discharge posture shown in FIG. 8 (D117). When the right arm 12 takes the discharge posture, the roulette ball 2A is discharged (D118). Then, the routine waits until the right arm 12 takes the standby posture (D119). After a rotation standby time has elapsed, the rotation of the wheel is stopped (D120). Then, this routine ends.

As shown in FIG. 21C, in the robot controller 61, it is determined whether the game has been started to run (D121). When the game is not started (D121: NO), this routine ends. Meanwhile, when the game has been started (D121: YES), the right arm 12 is controlled to take the transfer posture shown in FIG. 7 (D122). Then, the left arm 13 is controlled to take the attraction posture shown in FIG. 6 (D123). Then, the routine waits until the attraction operation is completed (D124).

The left arm 13 is controlled to take the transfer posture shown in FIG. 7 (D125). Then the routine waits until the transfer of the roulette ball 2A is completed (D126). Then, the right arm 12 is controlled to take the discharge posture of FIG. 8A (D127), and is kept in this posture until the discharge of the roulette ball 2A is completed (D128).

It is desirable that the right arm 12 is kept in this posture with compressed air ejected until the roulette ball 2A runs a plurality of laps on the roulette wheel. As shown in FIG. 8B, the shortest distance L2 between the leading end portion of the shooting mechanism 17 and the inner circumferential wall 31a of the roulette wheel 31 is set to be larger than the diameter L1 of the roulette ball 2A. Because of this, after the roulette ball 2A is discharged and runs a lap along the inner circumferential wall 31a of the roulette wheel 31, the roulette ball 2A passes through the gap between the shooting mechanism 17 and the inner circumferential wall 31a. The compressed air kept ejected from the shooting mechanism 17 when the roulette ball 2A passes through the gap pushes the roulette ball 2A to its movement direction, thereby to increase the speed of the spinning. Thus, in this arrangement, the spinning speed of the roulette ball 2A is adjustable by the compressed air. Then, the right arm 12 and the left arm 13 are controlled to take the standby postures of FIG. 5 (D129), and this routine ends.

(Detailed Operation of Dealer Substitute Device: Settlement Process)

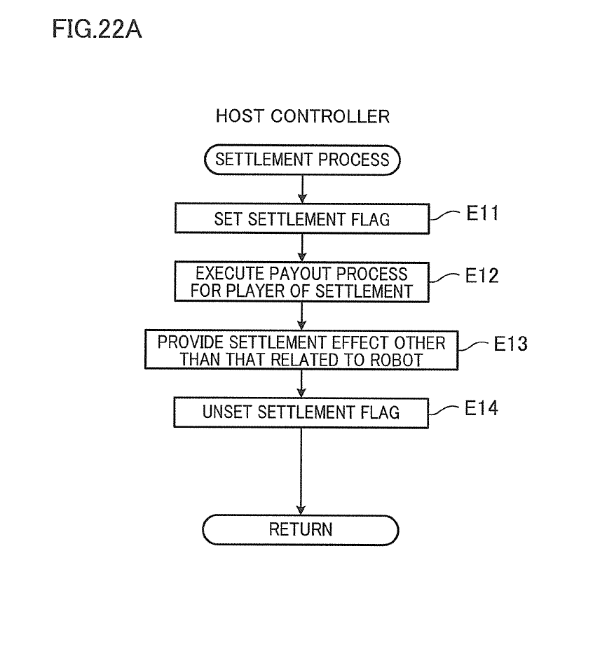

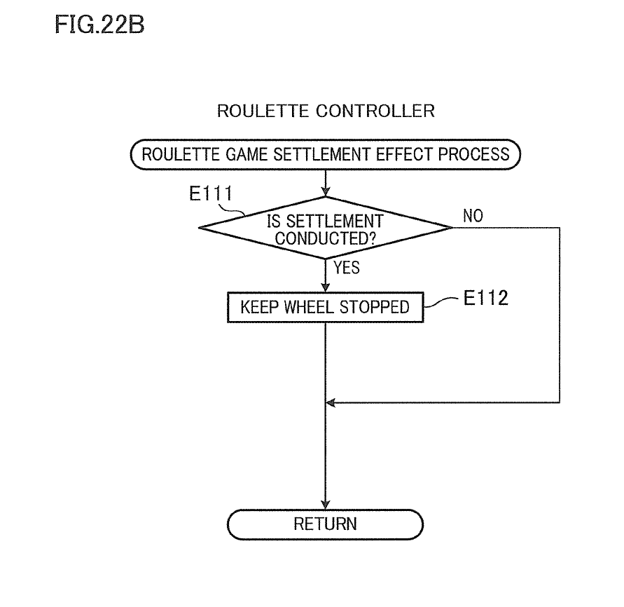

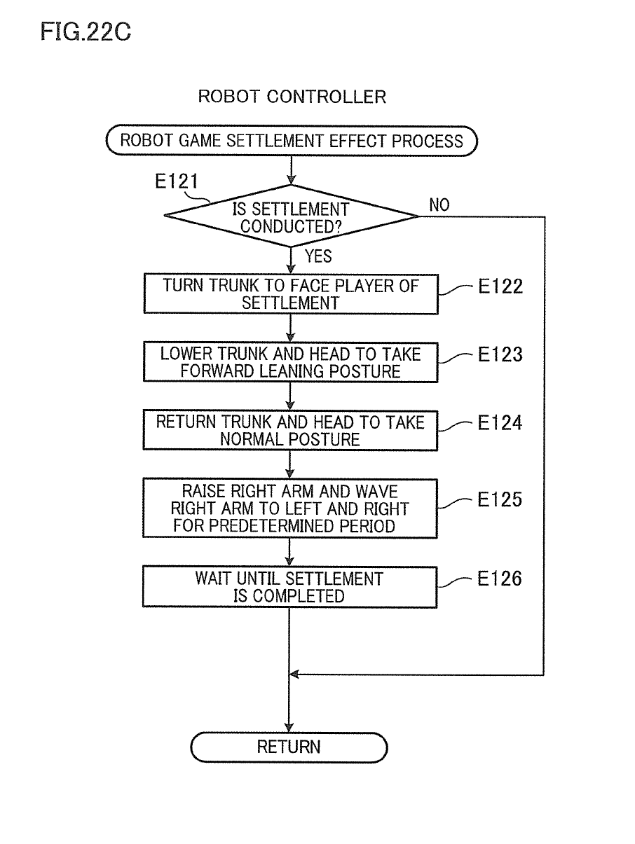

As shown in FIG. 22A, in the host controller 62, the settlement flag is set (E11). Then, the payout process is executed for a player who wants settlement (E12). Then, after settlement effect other than that related to the robotic device 10 is provided (E13), the settlement flag is unset (E14), and this routine ends.

As shown in FIG. 22B, in the roulette controller 31, it is determined whether the settlement is being conducted (E111). When the settlement is not being conducted (E111: NO), this routine ends. Meanwhile, when the settlement is being conducted (E111: YES), the wheel is kept stopped (E112), and this routine ends.

As shown in FIG. 22C, in the robot controller 61, it is determined whether the settlement is being conducted (E121). When the settlement is not being conducted (E121: NO), this routine ends. Meanwhile, when the settlement is being conducted (E121: YES), the trunk 11 is turned to face the player who wants the settlement (E122), as shown in FIG. 4. Then, after the trunk 11 and the head are controlled to be lowered to take a forward leaning posture (E123), the trunk 11 and the head are controlled to be raised to take a normal posture (E124). With this, the robotic device 10 bows to the player who wants the settlement. Thereafter, the right arm 12 is raised and is waved in the left-right direction for a predetermined period of time (E18C) in farewell from the robotic device 10 to the player who wants the settlement, and then this routine ends.

(Overview of Invention 1)

As shown in FIG. 1, according to an embodiment of the present invention, the dealer substitute device 1 includes: the at least one arm (right arm 12, left arm 13) configured to move the handling portion (first handling portion 14, second handling portion 15), with which the gaming tool 2 used in a game is handled, so as to position the handling portion at a predetermined position in a three-dimensional space; and the trunk 11 which supports the arm and is configured to perform effect operation to a player.

In the above arrangement, the gaming tool 2 is handled with the arm which is capable of moving the handling portion 14, 15 to a predetermined position in the three-dimensional space, and the trunk 11 supporting the arm performs the effect operation to the player, and thereby behavior close to an arm and trunk of a dealer handling the gaming tool 2 is produced. As a result, a gaming environment resembling the atmosphere in which a dealer handles the gaming tool 2 is provided to the player.

As shown in FIG. 3, the device of the present invention may further include: the communication mechanism 5 including the camera mechanism configured to acquire an image, the microphone mechanism configured to acquire sound, and the speaker mechanism configured to output sound, the communication mechanism being configured to communicate with the player; and the controller 6 configured to execute the process of obtaining player information based on the image of the player acquired by the camera mechanism and based on the sound of the player acquired by the microphone mechanism, and outputting response information corresponding to the player information through the speaker mechanism.

In this arrangement, communication with the player is conducted through the acquisition of the image and sound and through the output. With this, a gaming environment further resembling the atmosphere in which a human dealer handles the gaming tool 2 is provided to the player.

The device of the present invention may be arranged such that: the arm includes the plurality of arms which are arranged symmetrically with respect to the trunk 11; and a head 16 provided with the communication mechanism 5 is provided on top of the trunk 11.

In this arrangement, the arms are arranged symmetrically with respect to the trunk 11, and the head 16 provided with the communication mechanism 5 is provided on top of the trunk 11. With this, the dealer substitute device 1 has a humanoid shape, and therefore a gaming environment further resembling the atmosphere in which a human dealer handles the gaming tool 2 is provided to the player.

(Overview of Invention 2)

Further, as shown in FIG. 1 and FIG. 11, according to an embodiment of the present invention, the dealer substitute device 1 configured to handle the gaming tool 2 used in a game includes: the host controller 62 configured to exercise control related to handling of the gaming tool 2; and the robot controller 61 used for posture control for the effect operation of the robotic device 10, based on the control related to the handling of the gaming tool 2 and exercised by the host controller 62. With this, in the present invention, the stability of the game is improved.

Specifically, there has been developed automation of the operation of gaming machines having been conducted by a human dealer. For example, Specification of Japanese Patent No. 4676236 discloses a roulette apparatus as a kind of such a gaming machine. To be more specific, the roulette apparatus includes ball pockets into one of which a ball spun on a roulette wheel with marks arranged thereon falls, and the roulette apparatus is configured to eject air compressed by a compressor is into the one of the ball pockets holding the ball toward a bank track so as to spin the ball toward the bank track by pneumatic pressure. This roulette apparatus has a main control CPU as a controller, and is configured so that operation processing of a roulette game is intensively executed by the main control CPU.

However, in such a roulette apparatus, all the operations such as the operation of spinning the ball are performed by the main control CPU, and therefore the control processing takes time if the operation process for handling the ball is complicated. This may impair the stability of the game.

In view of the above, it is an objective of the present invention to provide the dealer substitute device 1 which improves the stability of the game.

According to an embodiment of the present invention, the dealer substitute device 1 configured to handle the gaming tool 2 used in a game includes: the first controller (host controller 62) configured to exercise control related to handling of the gaming tool 2 by a robot; and the second controller (robot controller 61) used for posture control for effect operation of the robot.

In the above structure, control related to handling of the gaming tool 2 is exercised by the first controller (host controller 62); and the posture control for the effect operation of the robot is exercised by the second controller (robot controller 61). With this, the stability of the game is improved as compared with the case where the control is made by the single controller 6.

The device in this embodiment of the present invention may be arranged such that: the robot includes the at least one arm 12, 13 configured to move the handling portion 14, 15, with which the gaming tool 2 is handled, so as to position the handling portion 14, 15 at a predetermined position in a three-dimensional space, and the trunk 11 which supports the arm 12, 13 and is configured to perform effect operation to a player; the first controller (host controller 62) is capable of executing the process of instructing the second controller (robot controller 61) about the postures of the arm 12, 13 and the trunk 11 to perform the effect operation; and the second controller (robot controller 61) is capable of executing the process of controlling the arm 12, 13 and the trunk 11 based on the instruction from the first controller (host controller 62).

In this arrangement, the first controller (host controller 62) and the second controller (robot controller 61) control the arm 12, 13 and the trunk 11 to move similarly to the arm(s) and the trunk of a dealer. With this, a gaming environment further resembling the atmosphere in which a human dealer handles the gaming tool 2 is provided to the player.

The device of this embodiment of the present invention may further include the communication mechanism 5 including the camera mechanism configured to acquire an image, the microphone mechanism configured to acquire sound, and the speaker mechanism configured to output sound, the communication mechanism 5 being configured to communicate with the player participating the game; and may be arranged such that the process of obtaining player information based on the image of the player acquired by the camera mechanism and based on the sound of the player acquired by the microphone mechanism, and outputting response information corresponding to the player information through the speaker mechanism is executed.

In this arrangement, communication with the player is conducted by the first controller (host controller 62) through the acquisition of the image and sound and through the output. With this, a gaming environment further resembling the atmosphere in which a human dealer handles the gaming tool 2 is provided to the player.

(Overview of Invention 3)

As shown in FIG. 1, according to an embodiment of the present invention, the dealer substitute device includes: the right arm 12 configured to move the first handling portion 14, with which the gaming tool 2 used in a game is handled, so as to position the first handling portion 14 at a predetermined position in a three-dimensional space; the left arm 13 configured to move the second handling portion 15, with which the gaming tool 2 is handled, so as to position the second handling portion 15 at a predetermined position in the three-dimensional space; and the trunk 11 which supports the right arm 12 and the left arm 13 symmetrically and is configured to perform effect operation to a player. This enables the device of the present invention to simulate the behavior of the arms and the trunk of a dealer by combining simple movement elements.

Specifically, there has been developed automation of the operation of gaming machines having been conducted by a human dealer. For example, Specification of Japanese Patent No. 4676236 discloses a roulette apparatus as a kind of such a gaming machine. To be more specific, the roulette apparatus includes ball pockets into one of which a ball spun on a roulette wheel with marks arranged thereon falls, and the roulette apparatus is configured to eject air compressed by a compressor is into the one of the ball pockets holding the ball toward a bank track so as to spin the ball toward the bank track by pneumatic pressure.

In such a roulette apparatus, all the operations such as the operation of spinning the ball are performed by the roulette apparatus, and therefore, the gaming environment without the presence of a dealer, which has a totally non-traditional atmosphere, is provided to a player. However, some players prefer the atmosphere in which a dealer is present. To deal with this, it is conceivable that a multiaxis articulated robot such as a welding robot may be used in place of a dealer. In this case, however, the movement of the dealer, which is the complicated combination of movement elements, has to be taught to the articulated robot.

In view of the above, an objective of the present invention to provide the dealer substitute device 1 capable of simulating the behavior of the arms and trunk of a dealer by combining simple movement elements.

According to and embodiment of the present invention, the dealer substitute device 1 includes: the first arm (right arm 12) configured to move the first handling portion 14, with which the gaming tool 2 used in a game is handled, so as to position the first handling portion 14 at a predetermined position in a three-dimensional space; the second arm (left arm 13) configured to move the second handling portion 15, with which the gaming tool 2 is handled, so as to position the second handling portion 15 at a predetermined position in the three-dimensional space; and the trunk 11 which supports the first arm (right arm 12) and the second arm (left arm 13) symmetrically and is configured to perform effect operation to a player.

In the above arrangement, the gaming tool 2 is handled with the first and second arms (the right arm 12 and the left arm 13) which are respectively capable of moving the first and second handling portions 14 and 15 to the respective predetermined positions in the three-dimensional space. With this, as compared with the case where the gaming tool 2 is handled with a single arm, the behavior of the arms and trunk of a dealer can be simulated by combining simple movement elements.

The device of this embodiment of the present invention may be arranged such that: the first handling portion 14 includes the holding mechanism 18 configured to hold the gaming tool 2; and the second handling portion 15 includes the shooting mechanism 17 configured to shoot the gaming tool 2 transferred from the first handling portion 14.

In the above arrangement, the mechanism and operation are simplified as compared with the case where the gaming tool 2 is held and shot using the handling portion 14, 15 of a single arm.

The device of the embodiment of the present invention may further include: the communication mechanism 5 including the camera mechanism configured to acquire an image, the microphone mechanism configured to acquire sound, and the speaker mechanism configured to output sound, the communication mechanism 5 being configured to communicate with a player participating the game; and the controller 6 configured to execute the process of obtaining player information based on the image of the player acquired by the camera mechanism and based on the sound of the player acquired by the microphone mechanism, and outputting response information corresponding to the player information through the speaker mechanism, and the device may be arranged such that the head 16 provided with the communication mechanism 5 is provided on top of the trunk 11.

In this arrangement, the first arm (right arm 12) and the second arm (left arm 13) are arranged symmetrically with respect to the trunk 11, and the head 16 provided with the communication mechanism 5 is provided on top of the trunk 11. With this, the dealer substitute device 1 has a humanoid shape, and therefore a gaming environment further resembling the atmosphere in which a human dealer handles the gaming tool 2 is provided to the player.

(Overview of Invention 4)

Further, as shown in FIG. 1 and FIG. 3, according to an embodiment of the present invention, the dealer substitute device includes: the at least one arm 12, 13 configured to move the handling portion 14, 15, with which the gaming tool 2 used in a game is handled, so as to position the handling portion 14, 15 at a predetermined position in a three-dimensional space; and the trunk 11 which supports the arm 12, 13 and is configured to perform effect operation to a player. The handling portion 14, 15 includes the shooting mechanism 17 a part of which contacts the gaming tool 2 is made of elastomer. This reduces the possibility that the gaming tool 2 and the holding mechanism 18 is damaged when a load is abruptly applied, e.g., when a collision occurs.

Specifically, there has been developed automation of the operation of gaming machines having been conducted by a human dealer. For example, Specification of Japanese Patent No. 4676236 discloses a roulette apparatus as a kind of such a gaming machine. To be more specific, the roulette apparatus is structured as follows: the roulette apparatus includes ball pockets into one of which a ball spun on a roulette wheel with marks arranged thereon falls; and air compressed by a compressor is ejected into the one of the ball pockets holding the ball toward a peripheral part of the roulette wheel, which is on its outer circumference, so as to spin the ball along the inner wall surface of the peripheral part by pneumatic pressure.

In the roulette apparatus as above, if the power of the compressed air is weak when the ball is sent from the ball packet toward the outer circumference side of the roulette wheel, the ball returns to the wheel on the inner circumference side before reaching the peripheral part of the roulette wheel. To prevent this, the power of the compressed air flow has to be increased to give momentum to the thus sent ball. However, if the power is increased, the ball and the inner circumferential wall of the roulette wheel are more likely to be damaged as a result of collision of the ball with the inner circumferential wall of the roulette wheel.

In view of the above, an objective of the present invention to provide the dealer substitute device 1 capable of reducing the possibility that the gaming tool 2 and the holding mechanism 18 are damaged when a load is abruptly applied, e.g., when a collision occurs.

According to an embodiment of the present invention, the dealer substitute device 1 includes: the at least one arm (the right arm 12, the left arm 13) configured to move the handling portion 14, 15, with which the gaming tool 2 used in a game is handled, so as to position the handling portion 14, 15 at a predetermined positions in a three-dimensional space; and the trunk 11 which supports the arm and is configured to perform effect operation to a player, and the handling portion 14, 15 includes the holding mechanism 18 a part of which contacts the gaming tool 2 is made of elastomer.

In the above arrangement, the part of the holding mechanism 18 of the handling portion 14, 15 which contacts the gaming tool 2 is made of elastomer. This makes it less likely that the roulette ball 2A and the holding mechanism 18 are damaged as a result of abrupt application of a load to the gaming tool 2 when the holding mechanism 18 of the handling portion 14, 15 is brought into contact with the gaming tool 2.

The device of the embodiment of the present invention may further include an air suction device (air compressor 72) configured to suck air, and the holding mechanism 18 may include: the sucker surface 181b configured to make surface contact with the gaming tool 2; and the suction opening 181a which is connected to the air suction device (air compressor 72) and opens onto the sucker surface 181b.

With the above arrangement, good operability is provided in holding the gaming tool 2 because the holding mechanism 18 attracts and holds the gaming tool 2 by the suction of air.

(Overview of Invention 5)

Further, as shown in FIG. 1 and FIG. 9A and FIG. 9B, according to an embodiment of the present invention, the dealer substitute device includes: the at least one arm 12, 13 configured to move the handling portion 14, 15, with which the roulette ball 2A used in a roulette game is handled, so as to position the handling portion 14, 15 at a predetermined position in a three-dimensional space; and the trunk 11 which supports the arm 12, 13 and is configured to perform effect operation to a player. The shooting mechanism 17 includes a tubular shape body 171 having: the reception hole 171a which is provided through its periphery and through which the roulette ball 2A is received; an air inlet (through hole 171b) which is on a one end side and through which compressed air enters; and a discharge portion (opening on the other end side) which is on the other end side and through which the roulette ball 2A pushed by the thus entering compressed air is discharged. This configuration of the present invention eliminates the necessity for moving the arm 12, 13 at the time of moving the roulette ball 2A, to enable simplification of the control of the arm 12, 13.

Specifically, there has been developed automation of the operation of gaming machines having been conducted by a human dealer. For example, Specification of Japanese Patent No. 4676236 discloses a roulette apparatus as a kind of such a gaming machine. To be more specific, the above document discloses the roulette apparatus including ball pockets into one of which a ball spun on a roulette wheel with marks arranged thereon falls, the roulette apparatus being configured to eject air compressed by a compressor is into the one of the ball pockets holding the ball toward a bank track so as to spin the ball toward the bank track by pneumatic pressure.

In such a roulette apparatus, all the operations such as the operation of spinning the ball are performed by the roulette apparatus, and therefore, the gaming environment without the presence of a dealer, which has a totally non-traditional atmosphere, is provided to a player. However, some players prefer the atmosphere in which a dealer is present. To deal with this, it is conceivable that a multiaxis articulated robot such as a welding robot may be used in place of a dealer. In this case, however, it is necessary to teach, to the articulated robot, the complicated movement element of the dealer to move the roulette ball 2A on the roulette wheel 31.

In view of the above, an objective of the present invention to provide the dealer substitute device 1 which enables simplification of the control of the arm by eliminating the necessity for moving the arm when moving the roulette ball 2A.

According to an embodiment of the present invention, the dealer substitute device 1 includes: the at least one arm 12, 13 configured to move the handling portion 14, 15, with which the roulette ball 2A used in a roulette game is handled, so as to position the handling portion 14, 15 at a predetermined position in a three-dimensional space; and the trunk 11 which supports the arm 12, 13 and is configured to perform effect operation to a player, and the handling portion 14, 15 includes the tubular shape body 171 having: the reception hole 171a which is provided through its periphery and through which the roulette ball 2A is received; an air inlet (through hole 171b) which is on a one end side and through which compressed air enters; and a discharge portion which is on the other end side and through which the roulette ball 2A pushed by the thus entering compressed air is discharged.

In the above-described arrangement, the tubular shape body 171 of the handling portion (14, 15) of the arm is configured to discharge the roulette ball 2A by pushing the roulette ball 2A using the compressed air, and this eliminates the necessity for moving the arm when moving the roulette ball 2A. Thus, the control of the arm is simplified.

According to an embodiment of the present invention, the dealer substitute device 1 includes: the first arm (right arm 12) configured to move the first handling portion 14, with which the roulette ball 2A used in a roulette game is handled, so as to position the handling portion 14 at a predetermined position in a three-dimensional space; the second arm (left arm 13) configured to move the second handling portion 15, with which the roulette ball 2A is handled, so as to position the second handling portion 15 at a predetermined position in the three-dimensional space; and the trunk 11 which supports the first arm (right arm 12) and the second arm (left arm 13) symmetrically and is configured to perform effect operation to a player. The first handling portion 14 includes the holding mechanism 18 configured to hold the roulette ball 2A; and the second handling portion 15 includes the tubular shape body 171 having: the reception hole 171a which is provided through its periphery and through which the roulette ball 2A is received; an air inlet (through hole 171b) which is on a one end side and through which compressed air enters; and a discharge portion (opening of the tubular shape body 171 on the free end side) which is on the other end side and through which the roulette ball 2A pushed by the thus entering compressed air is discharged.

In this arrangement, the behavior of the arms of the dealer handling the roulette ball 2A is simulated by combining simple movement elements. With this, the control of the arms 12 and 13 is simplified while a gaming environment further resembling the atmosphere in which a human dealer handles the gaming tool 2 is provided to the player.

As shown in FIG. 8B, the device of this embodiment of the present invention may be arranged such that: the shortest distance L2 between the handling portion 14, 15 and the inner circumferential wall 31a of the roulette wheel 31, in contact with which the roulette ball 2A spins, is set to be larger than the diameter L1 of the roulette ball 2A.

In this arrangement, the shortest distance L2 between the handling portion 14, 15 and the inner circumferential wall 31a of the roulette wheel 31 is set to be larger than the diameter L1 of the roulette ball 2A. Because of this, after the roulette ball 2A runs a lap along the inner circumferential wall 31a of the roulette wheel 31, the roulette ball 2A passes through the gap between the handling portion 14, 15 and the inner circumferential wall 31a. If compressed air is ejected at this time, the roulette ball 2A is pushed by the compressed air to its movement direction, and thereby the spinning speed of the roulette ball 2A is adjusted.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A dealer substitute device comprising:
an arm configured to move a handling portion, with which a gaming tool used in a game is handled, so as to position the handling portion at a predetermined position in a three-dimensional space; and
a trunk which supports the arm and is configured to perform effect operation to a player.

2. The dealer substitute device according to claim 1, further comprising:
a communication mechanism including a camera mechanism configured to acquire an image, a microphone mechanism configured to acquire sound, and a speaker mechanism configured to output sound, the communication mechanism being configured to communicate with the player; and
a controller configured to execute the process of obtaining player information based on the image of the player acquired by the camera mechanism and based on the sound of the player acquired by the microphone mechanism, and outputting response information corresponding to the player information through the speaker mechanism.

3. The dealer substitute device according to claim 2, wherein the arm includes a plurality of arms which are arranged symmetrically with respect to the trunk, and a head provided with the communication mechanism is provided on top of the trunk.
